(19) United States
(12) Patent Application Publication
(10) Pub. No.: US 2016/0180413 A1
(43) Pub. Date: Jun. 23, 2016

(54) METHODS AND SYSTEMS THAT AGGREGATE MULTI-MEDIA REVIEWS OF PRODUCTS AND SERVICES

(71) Applicant: ABBYY Development LLC, Moscow (RU)

(72) Inventor: Ding Yuan Tang, Pleasanton, CA (US)

(21) Appl. No.: 14/581,252

(22) Filed: Dec. 23, 2014

(51) Int. Cl. G06Q 30/02

(52) U.S. Cl. CPC G06Q 30/0282

(57) ABSTRACT

The current document is directed to methods and systems that facilitate authoring of multi-media reviews of products and services and that aggregate multi-media reviews of products and services submitted by multiple reviewers using distributed-computing technologies. In one disclosed implementation, a client-side application provides to reviewers authoring tools, lists of desired review topics, and analyses of submitted multi-media reviews. The client-side application communicates with one or more aggregation servers. The one or more aggregation servers distribute information about desired review topics, receive multi-media reviews submitted by reviewers using the client-side application, return analysis of submitted reviews to reviewers, and store multi-media reviews submitted by reviewers for subsequent access by, and dissemination to, retailers and other parties.

### TECHNICAL FIELD

The current document is related to distributed computing and multi-media presentations and, in particular, to methods and systems for creating and aggregating multi-media reviews of products and services.

### BACKGROUND

Reviews of products and services have long been used to promote retail sales. With the emergence of Internet-based e-commerce during the past 20 years, customer reviews and ratings have gained increased prominence and importance for facilitating retailing of products and services. Many consumers have grown to depend on review of products and services as an important component of the information that they assemble and consider as they make purchasing decisions. However, despite the many advanced capabilities for information transfer and display provided by modern distributed computer systems, reviews of products and services are, for the most past, text-based, often consisting of a few sentences or short paragraphs accompanied by a simple textural or graphical rating, such as a star-based rating. Moreover, in many cases, no reviews or only a few reviews are available for particular products and services. In addition, reviews often vary considerably in information content, readability, and objectiveness. As both traditional store-front retailers and Internet retailers continue to seek new advantages in their increasingly competitive retailing marketplaces, advances in customer-review solicitation and procurement and would be welcomed by both traditional store-front retailers and Internet retailers, their customers, of reviewers.

### SUMMARY

The current document is directed to methods and systems that facilitate authoring of multi-media reviews of products and services and that aggregate multi-media reviews of products and services submitted by multiple reviewers using distributed-computing technologies. In one disclosed implementation, a client-side application provides to reviewers authoring tools, lists of desired review topics, and analyses of submitted multi-media reviews. The client-side application communicates with one or more aggregation servers. The one or more aggregation servers distribute information about desired review topics, receive multi-media reviews submitted by reviewers using the client-side application, return analysis of submitted reviews to reviewers, and store multi-media reviews submitted by reviewers for subsequent access by, and dissemination to, retailers and other parties.

### BRIEF DESCRIPTION OF THE DRAWINGS

FIG. 1 provides a general architectural diagram for various types of computers.

FIG. 2 illustrates an Internet-connected distributed computer system.

FIG. 3 illustrates cloud computing. In the recently developed cloud-computing paradigm, computing cycles and data-storage facilities are provided to organizations and individuals by cloud-computing providers.

FIG. 4 illustrates generalized hardware and software components of a general-purpose computer system, such as a general-purpose computer system having an architecture similar to that shown in FIG. 1.

FIG. 5A illustrates two types of virtual machine and virtual-machine execution environments.

FIG. 5B illustrates two types of virtual machine and virtual machine execution environments.

FIG. 6 illustrates an example environment in which the currently disclosed methods and systems operate.

FIG. 7 illustrates, in block-diagram fashion, the basic aggregation operation performed by the distributed review-aggregation system.

FIG. 8A illustrates an example user interface provided by a client-side review-authoring and review-submission application.

FIG. 8B illustrates an example user interface provided by a client-side review-authoring and review-submission application.

FIG. 8C illustrates an example user interface provided by a client-side review-authoring and review-submission application.

FIG. 8D illustrates an example user interface provided by a client-side review-authoring and review-submission application.

FIG. 8E illustrates an example user interface provided by a client-side review-authoring and review-submission application.

FIG. 8F illustrates an example user interface provided by a client-side review-authoring and review-submission application.

FIG. 8G illustrates an example user interface provided by a client-side review-authoring and review-submission application.

FIG. 9A provides general descriptions of the implementation of the client-side-application and aggregation-server components of the distributed review-aggregation system.

FIG. 9B provides general description of the implementation of the client-side-application and aggregration-server components of the distributed review-aggregation system.

FIG. 10A provides a small portion of an example state-transition diagram for a client-side application component of a distributed review-aggregation system.

FIG. 10B provides a small portion of an example state-transition diagram for a client-side application component of a distributed review-aggregation system.

FIG. 11A illustrates a portion of the relational database tables.

FIG. 11B illustrates a portion of the relational database tables.

FIG. 11C illustrates a portion of the relational database tables.

FIG. 12 illustrates using control-flow diagrams, aggregation-server handling of various types of requests.

FIG. 13 illustrates using control-flow diagrams, aggregation-server handling of various types of requests.

FIG. 14 illustrates using control-flow diagrams, aggregation-server handling of various types of requests.

FIG. 15A illustrates using control-flow diagrams, aggregation-server handling of various types of requests.

FIG. 15B illustrates using control-flow diagrams, aggregation-server handling of various types of requests.

FIG. 15C illustrates using control-flow diagrams, aggregation-server handling of various types of requests.

FIG. 15D illustrates using control-flow diagrams, aggregation-server handling of various types of requests.

FIG. 15E illustrates using control-flow diagrams, aggregation-server handling of various types of requests.

FIG. 15F illustrates using control-flow diagrams, aggregation-server handling of various types of requests.

FIG. 16 illustrates using control-flow diagrams, aggregation-server handling of various types of requests.

### DETAILED DESCRIPTION

The current document is directed to methods and systems that facilitate authoring of reviews of products and services and that aggregate of multi-media reviews to allow the multi-media reviews to be accessed and used by retailers of the products and services. In a first subsection, overview of computers and distributed computing is provided. In a second subsection, a detailed description of currently disclosed methods and systems is provided.

### Computer Hardware, Distributed Computational Systems, and Virtualization

The term “abstraction” is not, in any way, intended to mean or suggest an abstract idea or concept. Computational abstractions are tangible, physical interfaces that are implemented, ultimately, using physical computer hardware, data-storage devices, and communications systems. Instead, the term “abstraction” refers, in the current discussion, to a logical level of functionality encapsulated within one or more concrete, tangible, physically-implemented computer systems with defined interfaces through which electronically-encoded data is exchanged, process execution launched, and electronic services are provided. Interfaces may include graphical and textual data displayed on physical display devices as well as computer programs and routines that control physical computer processors to carry out various tasks and operations and that are invoked through electronically implemented application programming interfaces (“APIs”) and other electronically implemented interfaces. There is a tendency among those unfamiliar with modern technology and science to misinterpret the terms “abstract” and “abstraction,” when used to describe certain aspects of modern computing. For example, one frequently encounters assertions that, because a computational system is described in terms of abstractions, functional layers, and interfaces, the computational system is somehow different from a physical machine or device. Such allegations are unfounded. One only needs to disconnect a computer system or group of computer systems from their respective power supplies to appreciate the physical, machine nature of complex computer technologies. One also frequently encounters statements that characterize a computational technology as being “only software,” and thus not a machine or device. Software is essentially a sequence of encoded symbols, such as a printout of a computer program or digitally encoded computer instructions sequentially stored in a file on an optical disk or within an electromechanical mass-storage device. Software alone can do nothing. It is only when encoded computer instructions are loaded into an electronic memory within a computer system and executed on a physical processor that so-called “software implemented” functionality is provided. The digitally encoded computer instructions are an essential and physical control component of processor-controlled machines and devices, no less essential and physical than a cam-shaft control system in an internal-combustion engine. Multi-cloud aggregations, cloud-computing services, virtual-machine containers and virtual machines, communications interfaces, and many of the other topics discussed below are tangible, physical components of physical, electro-optical-mechanical computer systems.

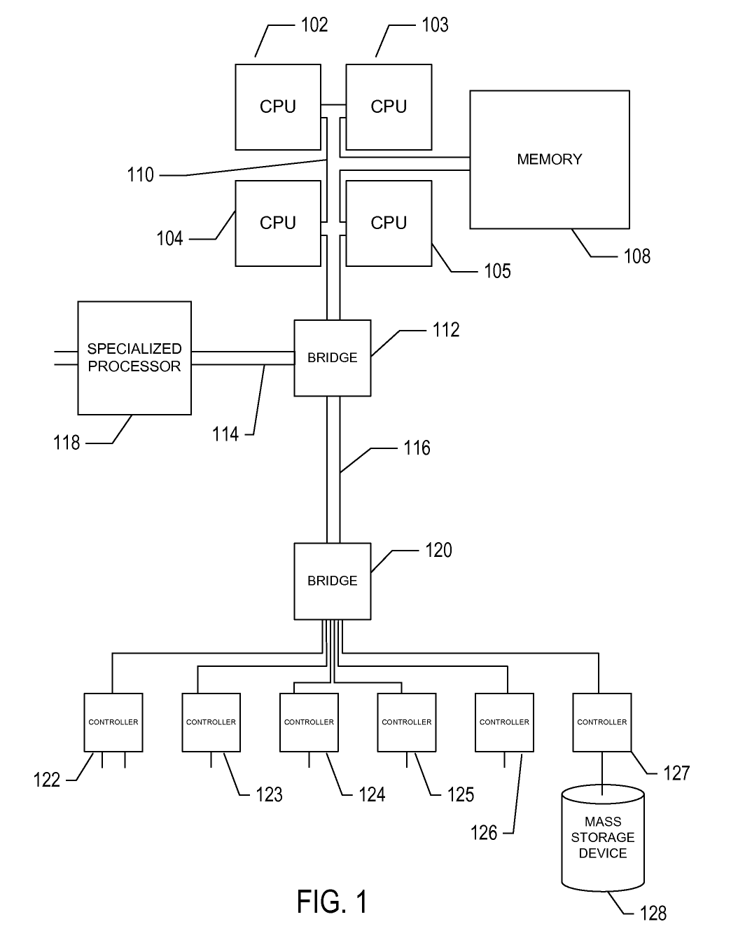

FIG. 1 provides a general architectural diagram for various types of computers. Computers that receive, process, and store multi-media reviews of products and services may be described by the general architectural diagram shown in FIG. 1, for example. The computer system contains one or multiple central processing units (“CPUs”) 102-105, one or more electronic memories 108 interconnected with the CPUs by a CPU/memory-subsystem bus 110 or multiple busses, a first bridge 112 that interconnects the CPU/memory-subsystem bus 110 with additional busses 114 and 116, or other types of high-speed interconnection media, including multiple, high-speed serial interconnects. These busses or serial interconnections, in turn, connect the CPUs and memory with specialized processors, such as a graphics processor 118, and with one or more additional bridges 120, which are interconnected with high-speed serial links or with multiple controllers 122-127, such as controller 127, that provide access to various different types of mass-storage devices 128, electronic displays, input devices, and other such components, subcomponents, and computational resources. It should be noted that computer-readable data-storage devices include optical and electromagnetic disks, electronic memories, and other physical data-storage devices. Those familiar with modern science and technology appreciate that electromagnetic radiation and propagating signals do not store data for subsequent retrieval, and can transiently “store” only a byte or less of information per mile, far less information than needed to encode even the simplest of routines.

Of course, there are many different types of computer-system architectures that differ from one another in the number of different memories, including different types of hierarchical cache memories, the number of processors and the connectivity of the processors with other system components, the number of internal communications busses and serial links, and in many other ways. However, computer systems generally execute stored programs by fetching instructions from memory and executing the instructions in one or more processors. Computer systems include general-purpose computer systems, such as personal computers (“PCs”), various types of servers and workstations, and higher-end mainframe computers, but may also include a plethora of various types of special-purpose computing devices, including data-storage systems, communications routers, network nodes, tablet computers, and mobile telephones.

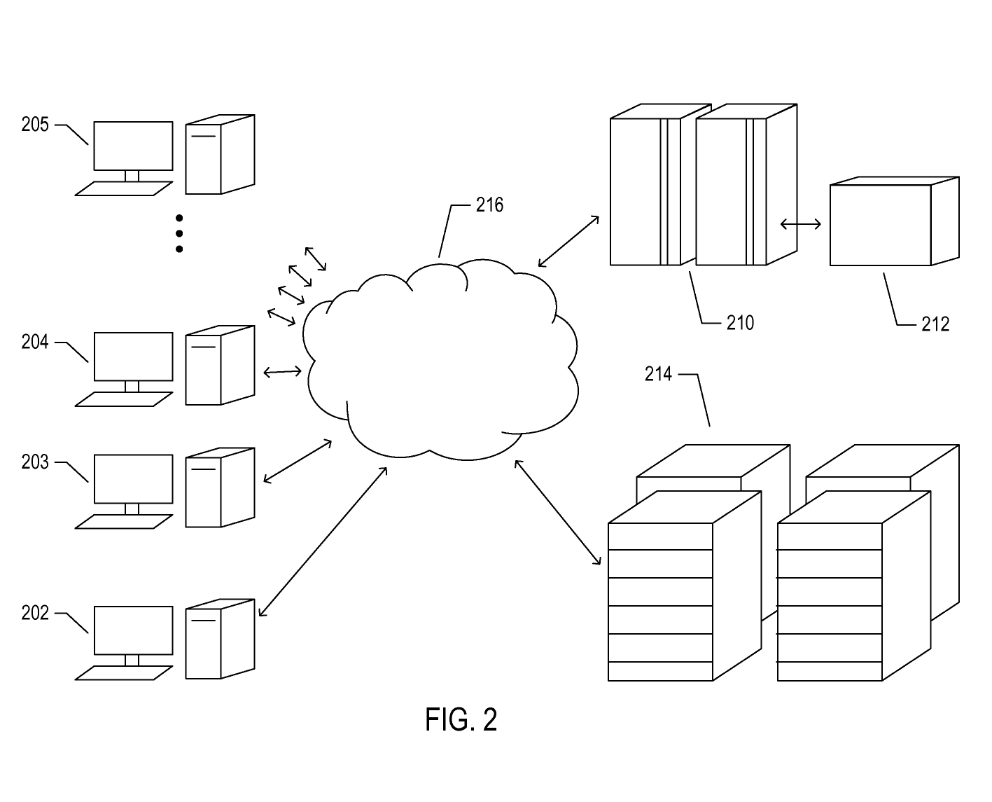

FIG. 2 illustrates an Internet-connected distributed computer system. As communications and networking technologies have evolved in capability and accessibility, and as the computational bandwidths, data-storage capacities, and other capabilities and capacities of various types of computer systems have steadily and rapidly increased, much of modern computing now generally involves large distributed systems and computers interconnected by local networks, wide-area networks, wireless communications, and the Internet. FIG. 2 shows a typical distributed system in which a large number of PCs 202-205, a high-end distributed mainframe system 210 with a large data-storage system 212, and a large computer center 214 with large numbers of rack-mounted servers or blade servers all interconnected through various communications and networking systems that together comprise the Internet 216. Such distributed computing systems provide diverse arrays of functionalities. For example, a PC user sitting in a home office may access hundreds of millions of different web sites provided by hundreds of thousands of different web servers throughout the world and may access high-computational-bandwidth computing services from remote computer facilities for running complex computational tasks.

Until recently, computational services were generally provided by computer systems and data centers purchased, configured, managed, and maintained by service-provider organizations. For example, an e-commerce retailer generally purchased, configured, managed, and maintained a data center including numerous web servers, back-end computer systems, and data-storage systems for serving web pages to remote customers, receiving orders through the web-page interface, processing the orders, tracking completed orders, and other myriad different tasks associated with an e-commerce enterprise.

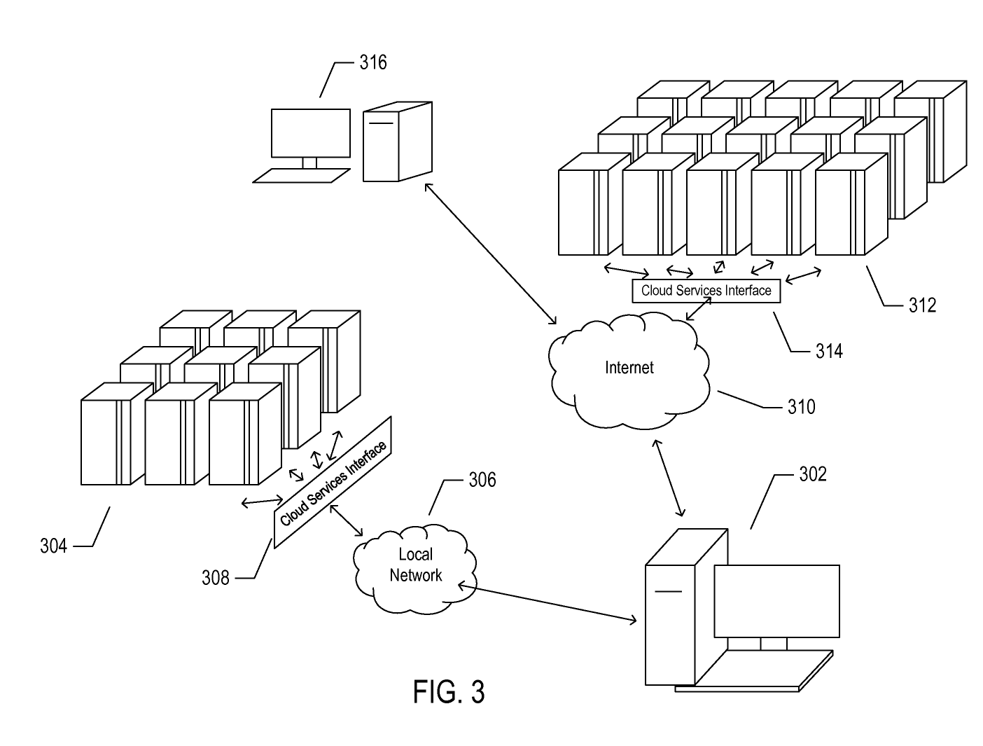

FIG. 3 illustrates cloud computing. In the recently developed cloud-computing paradigm, computing cycles and data-storage facilities are provided to organizations and individuals by cloud-computing providers. In addition, larger organizations may elect to establish private cloud-computing facilities in addition to, or instead of, subscribing to computing services provided by public cloud-computing service providers. In FIG. 3, a system administrator for an organization, using a PC 302, accesses the organization's private cloud 304 through a local network 306 and private-cloud interface 308 and also accesses, through the Internet 310, a public cloud 312 through a public-cloud services interface 314. The administrator can, in either the case of the private cloud 304 or public cloud 312, configure virtual computer systems and even entire virtual data centers and launch execution of application programs on the virtual computer systems and virtual data centers in order to carry out any of many different types of computational tasks. As one example, a small organization may configure and run a virtual data center within a public cloud that executes web servers to provide an e-commerce interface through the public cloud to remote customers of the organization, such as a user viewing the organization's e-commerce web pages on a remote user system 316.

Cloud-computing facilities are intended to provide computational bandwidth and data-storage services much as utility companies provide electrical power and water to consumers. Cloud computing provides enormous advantages to small organizations without the resources to purchase, manage, and maintain in-house data centers. Such organizations can dynamically add and delete virtual computer systems from their virtual data centers within public clouds in order to track computational-bandwidth and data-storage needs, rather than purchasing sufficient computer systems within a physical data center to handle peak computational-bandwidth and data-storage demands. Moreover, small organizations can completely avoid the overhead of maintaining and managing physical computer systems, including hiring and periodically retraining information-technology specialists and continuously paying for operating-system and database-management-system upgrades. Furthermore, cloud-computing interfaces allow for easy and straightforward configuration of virtual computing facilities, flexibility in the types of applications and operating systems that can be configured, and other functionalities that are useful even for owners and administrators of private cloud-computing facilities used by a single organization.

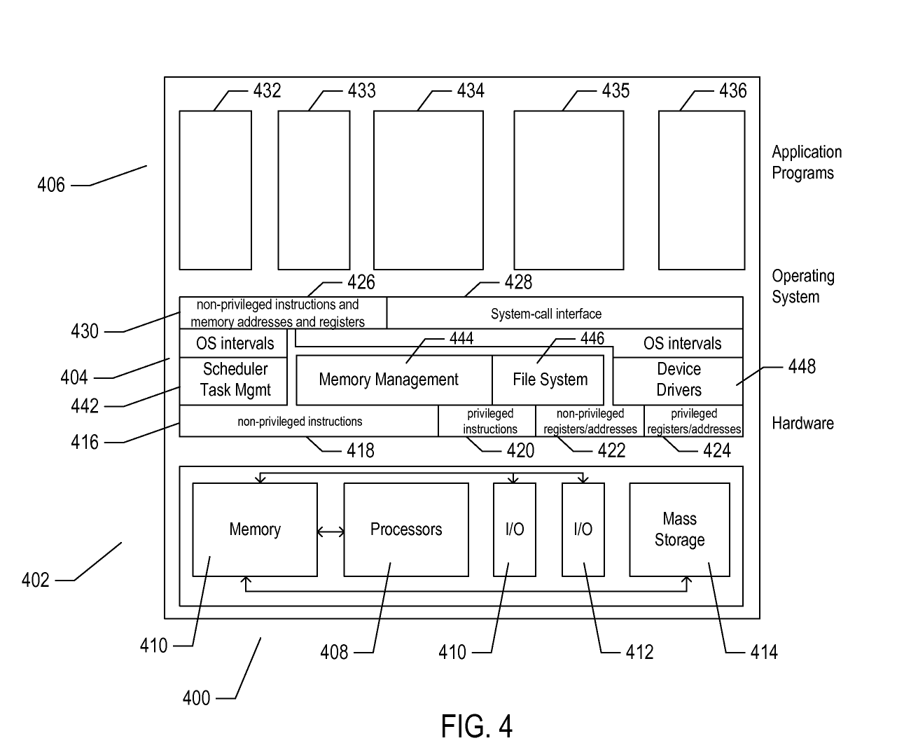

FIG. 4 illustrates generalized hardware and software components of a general-purpose computer system, such as a general-purpose computer system having an architecture similar to that shown in FIG. 1. The computer system 400 is often considered to include three fundamental layers: (1) a hardware layer or level 402; (2) an operating-system layer or level 404; and (3) an application-program layer or level 406. The hardware layer 402 includes one or more processors 408, system memory 410, various different types of input-output (“I/O”) devices 410 and 412, and mass-storage devices 414. Of course, the hardware level also includes many other components, including power supplies, internal communications links and busses, specialized integrated circuits, many different types of processor-controlled or microprocessor-controlled peripheral devices and controllers, and many other components. The operating system 404 interfaces to the hardware level 402 through a low-level operating system and hardware interface 416 generally comprising a set of non-privileged computer instructions 418, a set of privileged computer instructions 420, a set of non-privileged registers and memory addresses 422, and a set of privileged registers and memory addresses 424. In general, the operating system exposes non-privileged instructions, non-privileged registers, and non-privileged memory addresses 426 and a system-call interface 428 as an operating-system interface 430 to application programs 432-436 that execute within an execution environment provided to the application programs by the operating system. The operating system, alone, accesses the privileged instructions, privileged registers, and privileged memory addresses. By reserving access to privileged instructions, privileged registers, and privileged memory addresses, the operating system can ensure that application programs and other higher-level computational entities cannot interfere with one another's execution and cannot change the overall state of the computer system in ways that could deleteriously impact system operation. The operating system includes many internal components and modules, including a scheduler 442, memory management 444, a file system 446, device drivers 448, and many other components and modules. To a certain degree, modern operating systems provide numerous levels of abstraction above the hardware level, including virtual memory, which provides to each application program and other computational entities a separate, large, linear memory-address space that is mapped by the operating system to various electronic memories and mass-storage devices. The scheduler orchestrates interleaved execution of various different application programs and higher-level computational entities, providing to each application program a virtual, stand-alone system devoted entirely to the application program. From the application program's standpoint, the application program executes continuously without concern for the need to share processor resources and other system resources with other application programs and higher-level computational entities. The device drivers abstract details of hardware-component operation, allowing application programs to employ the system-call interface for transmitting and receiving data to and from communications networks, mass-storage devices, and other I/O devices and subsystems. The file system 436 facilitates abstraction of mass-storage-device and memory resources as a high-level, easy-to-access, file-system interface. Thus, the development and evolution of the operating system has resulted in the generation of a type of multi-faceted virtual execution environment for application programs and other higher-level computational entities.

While the execution environments provided by operating systems have proved to be an enormously successful level of abstraction within computer systems, the operating-system-provided level of abstraction is nonetheless associated with difficulties and challenges for developers and users of application programs and other higher-level computational entities. One difficulty arises from the fact that there are many different operating systems that run within various different types of computer hardware. In many cases, popular application programs and computational systems are developed to run on only a subset of the available operating systems, and can therefore be executed within only a subset of the various different types of computer systems on which the operating systems are designed to run. Often, even when an application program or other computational system is ported to additional operating systems, the application program or other computational system can nonetheless run more efficiently on the operating systems for which the application program or other computational system was originally targeted. Another difficulty arises from the increasingly distributed nature of computer systems. Although distributed operating systems are the subject of considerable research and development efforts, many of the popular operating systems are designed primarily for execution on a single computer system. In many cases, it is difficult to move application programs, in real time, between the different computer systems of a distributed computer system for high-availability, fault-tolerance, and load-balancing purposes. The problems are even greater in heterogeneous distributed computer systems which include different types of hardware and devices running different types of operating systems. Operating systems continue to evolve, as a result of which certain older application programs and other computational entities may be incompatible with more recent versions of operating systems for which they are targeted, creating compatibility issues that are particularly difficult to manage in large distributed systems.

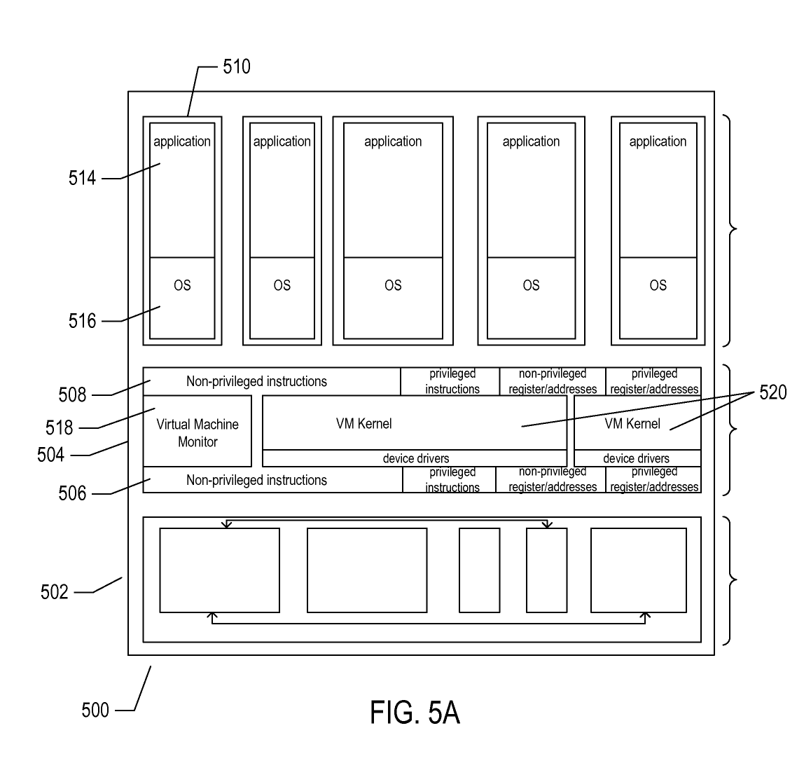

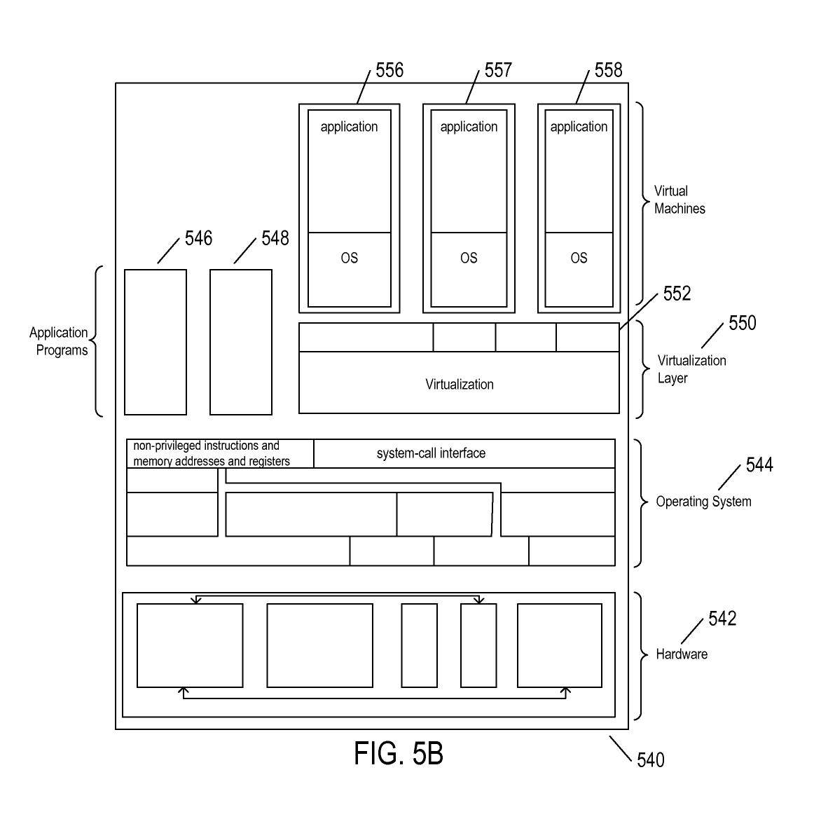

For all of these reasons, a higher level of abstraction, referred to as the “virtual machine,” has been developed and evolved to further abstract computer hardware in order to address many difficulties and challenges associated with traditional computing systems, including the compatibility issues discussed above. FIGS. 5A-B illustrate two types of virtual machine and virtual-machine execution environments. FIGS. 5A-B use the same illustration conventions as used in FIG. 4. FIG. 5A shows a first type of virtualization. The computer system 500 in FIG. 5A includes the same hardware layer 502 as the hardware layer 402 shown in FIG. 4. However, rather than providing an operating system layer directly above the hardware layer, as in FIG. 4, the virtualized computing environment illustrated in FIG. 5A features a virtualization layer 504 that interfaces through a virtualization-layer/hardware-layer interface 506, equivalent to interface 416 in FIG. 4, to the hardware. The virtualization layer provides a hardware-like interface 508 to a number of virtual machines, such as virtual machine 510, executing above the virtualization layer in a virtual-machine layer 512. Each virtual machine includes one or more application programs or other higher-level computational entities packaged together with an operating system, referred to as a “guest operating system,” such as application 514 and guest operating system 516 packaged together within virtual machine 510. Each virtual machine is thus equivalent to the operating-system layer 404 and application-program layer 406 in the general-purpose computer system shown in FIG. 4. Each guest operating system within a virtual machine interfaces to the virtualization-layer interface 508 rather than to the actual hardware interface 506. The virtualization layer partitions hardware resources into abstract virtual-hardware layers to which each guest operating system within a virtual machine interfaces. The guest operating systems within the virtual machines, in general, are unaware of the virtualization layer and operate as if they were directly accessing a true hardware interface. The virtualization layer ensures that each of the virtual machines currently executing within the virtual environment receive a fair allocation of underlying hardware resources and that all virtual machines receive sufficient resources to progress in execution. The virtualization-layer interface 508 may differ for different guest operating systems. For example, the virtualization layer is generally able to provide virtual hardware interfaces for a variety of different types of computer hardware. This allows, as one example, a virtual machine that includes a guest operating system designed for a particular computer architecture to run on hardware of a different architecture. The number of virtual machines need not be equal to the number of physical processors or even a multiple of the number of processors.

The virtualization layer includes a virtual-machine-monitor module 518 (“VMM”) that virtualizes physical processors in the hardware layer to create virtual processors on which each of the virtual machines executes. For execution efficiency, the virtualization layer attempts to allow virtual machines to directly execute non-privileged instructions and to directly access non-privileged registers and memory. However, when the guest operating system within a virtual machine accesses virtual privileged instructions, virtual privileged registers, and virtual privileged memory through the virtualization-layer interface 508, the accesses result in execution of virtualization-layer code to simulate or emulate the privileged resources. The virtualization layer additionally includes a kernel module 520 that manages memory, communications, and data-storage machine resources on behalf of executing virtual machines (“VM kernel”). The VM kernel, for example, maintains shadow page tables on each virtual machine so that hardware-level virtual-memory facilities can be used to process memory accesses. The VM kernel additionally includes routines that implement virtual communications and data-storage devices as well as device drivers that directly control the operation of underlying hardware communications and data-storage devices. Similarly, the VM kernel virtualizes various other types of I/O devices, including keyboards, optical-disk drives, and other such devices. The virtualization layer essentially schedules execution of virtual machines much like an operating system schedules execution of application programs, so that the virtual machines each execute within a complete and fully functional virtual hardware layer.

FIG. 5B illustrates a second type of virtualization. In FIG. 5B, the computer system 540 includes the same hardware layer 542 and software layer 544 as the hardware layer 402 shown in FIG. 4. Several application programs 546 and 548 are shown running in the execution environment provided by the operating system. In addition, a virtualization layer 550 is also provided, in computer 540, but, unlike the virtualization layer 504 discussed with reference to FIG. 5A, virtualization layer 550 is layered above the operating system 544, referred to as the “host OS,” and uses the operating system interface to access operating-system-provided functionality as well as the hardware. The virtualization layer 550 comprises primarily a VMM and a hardware-like interface 552, similar to hardware-like interface 508 in FIG. 5A. The virtualization-layer/hardware-layer interface 552, equivalent to interface 416 in FIG. 4, provides an execution environment for a number of virtual machines 556-558, each including one or more application programs or other higher-level computational entities packaged together with a guest operating system.

In FIGS. 5A-B, the layers are somewhat simplified for clarity of illustration. For example, portions of the virtualization layer 550 may reside within the host-operating-system kernel, such as a specialized driver incorporated into the host operating system to facilitate hardware access by the virtualization layer.

It should be noted that virtual hardware layers, virtualization layers, and guest operating systems are all physical entities that are implemented by computer instructions stored in physical data-storage devices, including electronic memories, mass-storage devices, optical disks, magnetic disks, and other such devices. The term “virtual” does not, in any way, imply that virtual hardware layers, virtualization layers, and guest operating systems are abstract or intangible. Virtual hardware layers, virtualization layers, and guest operating systems execute on physical processors of physical computer systems and control operation of the physical computer systems, including operations that alter the physical states of physical devices, including electronic memories and mass-storage devices. They are as physical and tangible as any other component of a computer since, such as power supplies, controllers, processors, busses, and data-storage devices.

Many implementations of the distributed review-aggregation system, discussed in the following subsection, employ large numbers of virtual servers within virtual data centers provided by cloud-computing facilities. Other implementations may employ standalone aggregation servers and various types of private data centers. In all implementations, the distributed review-aggregation system consists of complex hardware platforms, various electronic user devices, and control components stored and executed within these hardware platforms and electronic user devices that, in part, comprise millions of electronically stored processor instructions.

### The Currently Disclosed Distributed Review-Aggregation System

Currently, reviews of products and services provided by consumers and purchasers to Internet retailers are generally short, text-based reviews accompanied by a graphical or textural rating, such as a number of stars representing a ratio of assigned stars to the maximum possible number of assignable stars. These reviews are often furnished to Internet retailers through simple web-page-based interfaces that allow a consumer to type a review into a text-entry window, using a keyboard, and to assign a rating by clicking some number of stars within a row containing the maximum number of stars that can be assigned to a particular product or service. Text-based reviews are easy to write, easy to collect via simple web-page interfaces, and generally easy for potential customers to read and understand. However, these text-based reviews do not take advantage of the many multi-media capabilities of modern distributed computer systems and modern user devices, including mobile phones, laptops, tablets, and personal computers. Furthermore, reviews are generally provided through retailer-specific web-page interfaces, which potential reviewers need to find and learn to use. In the fast-paced world of Internet retailing, users may have little incentive to spend the time to figure out how to submit reviews to retailers. As a result, the quantity of well-written, useful reviews available for display to potential consumers and purchasers by Internet retailers may fail to meet the needs of the retailers and their potential consumers and purchasers. Furthermore, many retailers may lack the expertise and resources to solicit and collect reviews, particularly for products and services sold predominantly in storefronts and other retail locations. Potential consumers and purchasers may also wonder whether reviews displayed by retailers have been edited to appear more favorable than intended by the reviewers or represent only a small, favorable portion of a much larger body of less sanguine reviews, and the reviews that are displayed often vary widely in useful-information content.

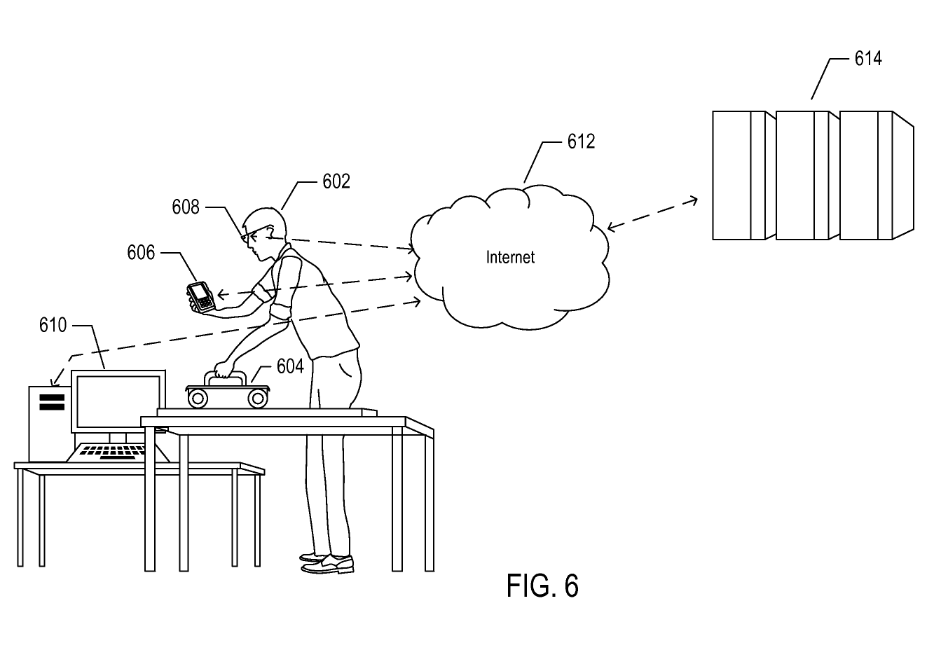

The current document is directed to methods and systems that facilitate authoring of multi-media reviews of products and services by consumers, purchasers, and/or users of the products and services and that collect and store the reviews by aggregation servers for subsequent access by, and display to, retailers seeking to acquire reviews and/or potential customers and purchasers seeking product and service information. FIG. 6 illustrates an example environment in which the currently disclosed methods and systems operate. In FIG. 6, a purchaser and user 602 of a hand-held product 604 is producing a multi-media review of the product using a mobile phone 606, a wearable computing device embedded within a pair of glasses 608, and a personal computer 610. The mobile phone 606, wearable computing device 608, and personal computer 610 can intercommunicate via the Internet 612. A client-side review-authoring application, referred to below as the “client-side application” or “client application,” runs on one or more of the user's devices to collect different types of information from the user's devices and packages this information into a multi-media review. The client-side application submits the completed review through the Internet to an aggregation server running within a cloud-computing facility 614 or other private or public data center as part of a distributed review-aggregation system. Reviews collected from users are subsequently made available by the distributed review-aggregation system, which includes aggregation servers and other facilities within one or more cloud-computing facilities or other private or public data centers, to retailers seeking consumer reviews for inclusion in web sites, kiosk displays, or other review-presentation facilities and, in certain cases, to potential consumers and purchasers and other interested parties. The reviewer 602 may collect still photos, videos, and audio presentations through one or more of the various devices employed by the reviewer and may also provide textural information through keyboard entry to the mobile phone 606 or personal computer 610. As personal electronic devices continue to develop, reviewers may soon routinely collect three-dimensional images, generate automated animations, and collect many additional types of media objects for inclusion in multi-media reviews. The distributed review-aggregation system, in certain implementations, provides monetary or credit-based remuneration to reviewers in order to incentivize reviewers to furnish multi-media reviews on desired topics. In certain implementations, the distributed review-aggregation system sells and/or rents multi-media reviews to retailers and to others interested in accessing the collected multi-media reviews. As part of the purchase and/or rental agreements, the distributed review-aggregation system may limit the ability of reviewers to edit or extract only portions of purchased or rented reviews and may require retailers to display trademarks or other indications that the reviews were obtained from the retail aggregator in order to increase public confidence in the authenticity and completeness of reviews displayed by retailers to potential consumers and purchasers. Reviewers may maintain local copies of submitted multi-media reviews or store copies in storage facilities made available by social networking sites and/or cloud-computing facilities to facilitate monitoring of the authenticity and completeness of reviews purchased from the distributed review-aggregation system and displayed by retailers and other parties. The distributed review-aggregation system may provide any of many different types of purchase and licensing options to reviewers to allow reviewers to maintain partial rights to reviews submitted by the reviewers to the distributed review-aggregation system.

Multi-media consumer reviews provide many advantages to consumers of the reviews. It is often far more interesting and informative to watch a video of a product being used or a service being performed than to read a short textural description of a product or service. Reviewers often communicate emotions and reactions more effectively using still photographs, video clips, and audio tracks than they are able to communicate by writing alone. The many different types of media that can be incorporated within a multi-media review allow reviewers greater creativity and flexibility in crafting reviews and, when incentivized by remuneration from the distributed review-aggregation system, this potential for creativity may result in a far more interesting and engaging selection of useful information than could be produced by even the most sophisticated of marketing organizations.

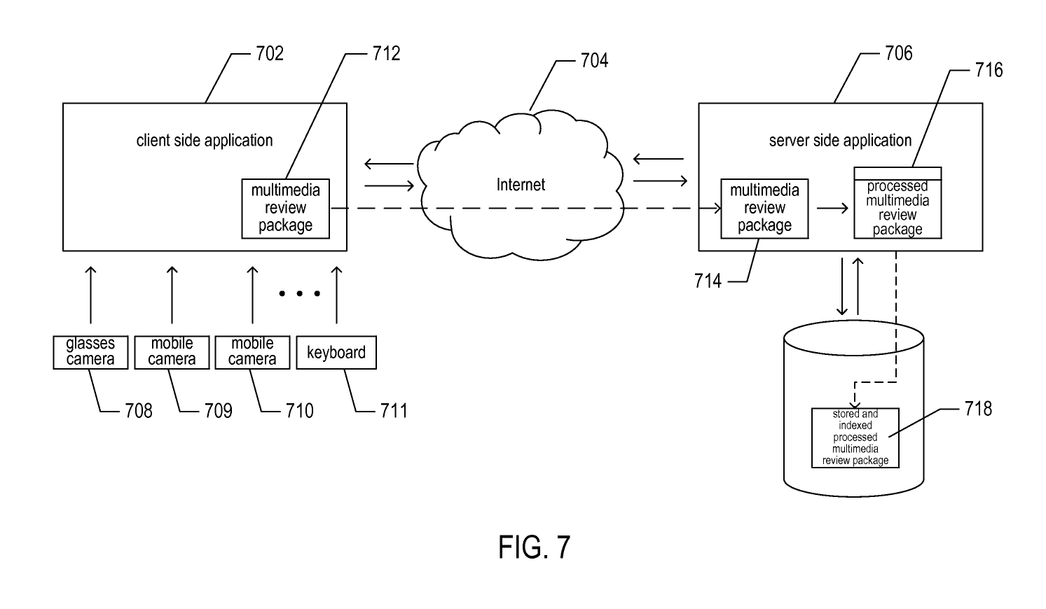

FIG. 7 illustrates, in block-diagram fashion, the basic aggregation operation performed by the distributed review-aggregation system. As shown in FIG. 7, a client-side application 702 runs in one or multiple user devices and communicates, via the Internet 704, with a server-side application running on one or more aggregation servers 706 within a cloud-computing facility or other private or public data center. The client-side application collects various different types of information output from various of the user's personal devices 708-711 and assembles the information, according to control inputs provided by the reviewer, into a multi-media review package 712 that the client-side application electronically transfers to the server-side application 714. The server-side application processes the received multi-media review package into a processed multi-media review package 716 and stores the processed multi-media review package in one or more data-storage facilities 718. In general, the processed multi-media review packages may be stored and indexed within any of various different types of database systems in order to facilitate rapid and intelligent retrieval for subsequent provision to retailers and other interested parties.

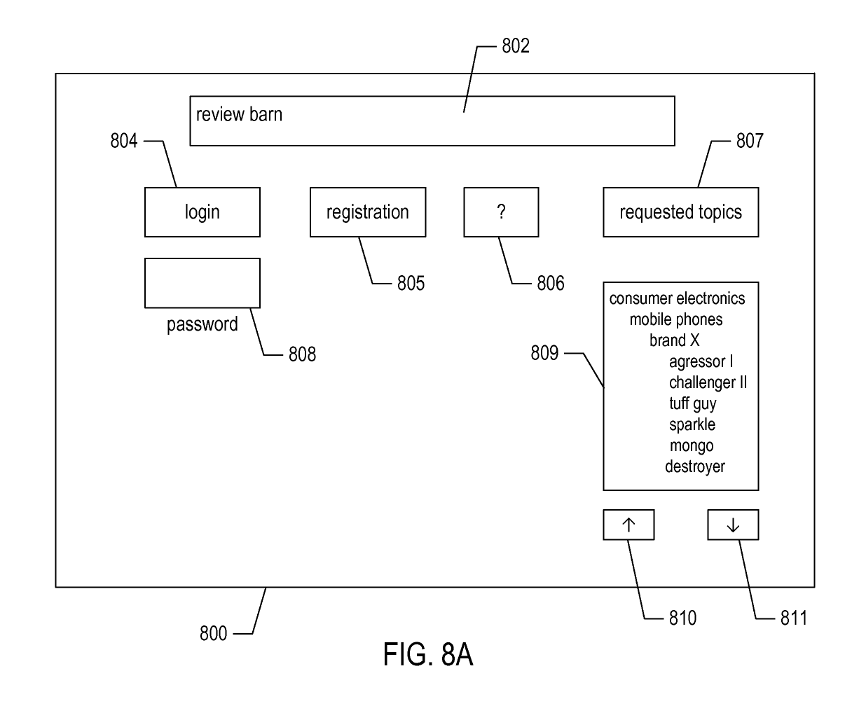

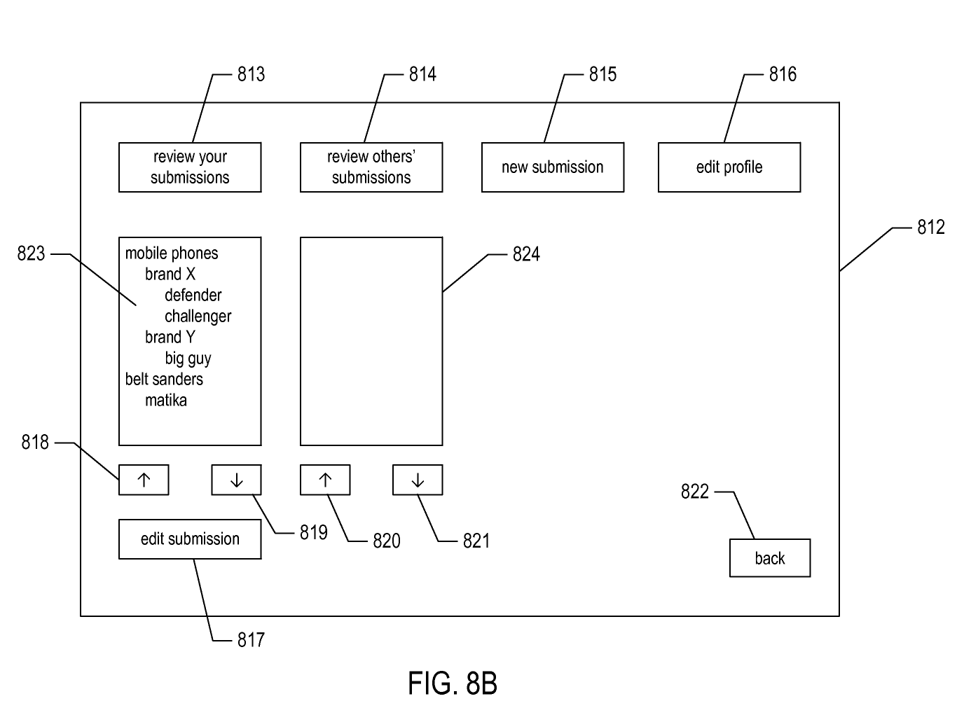

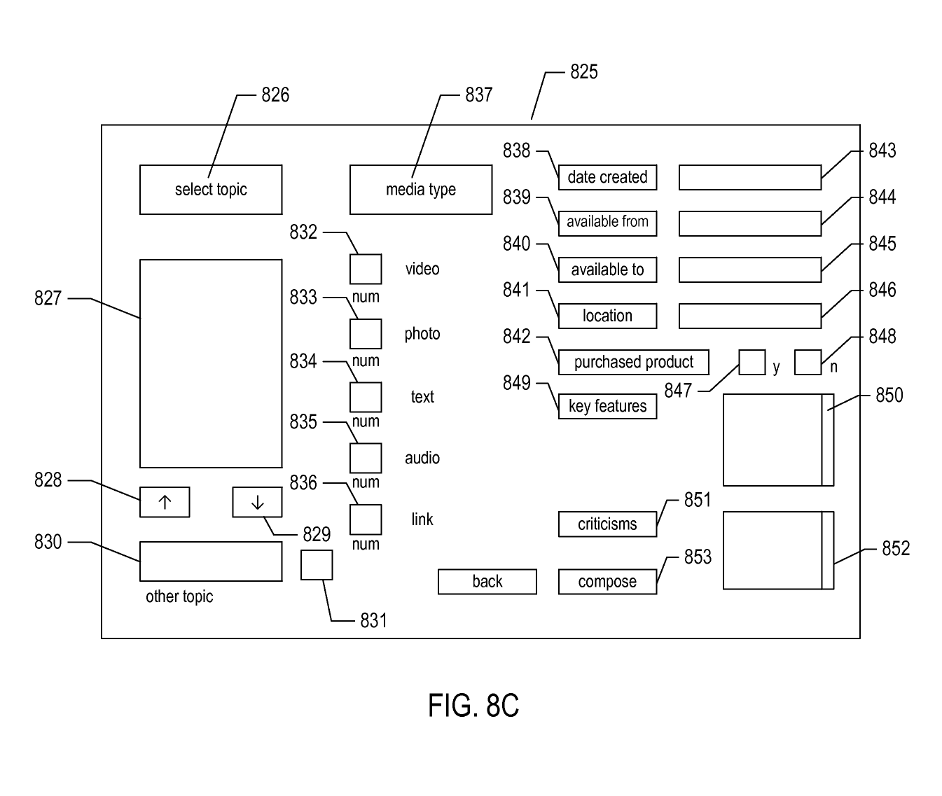

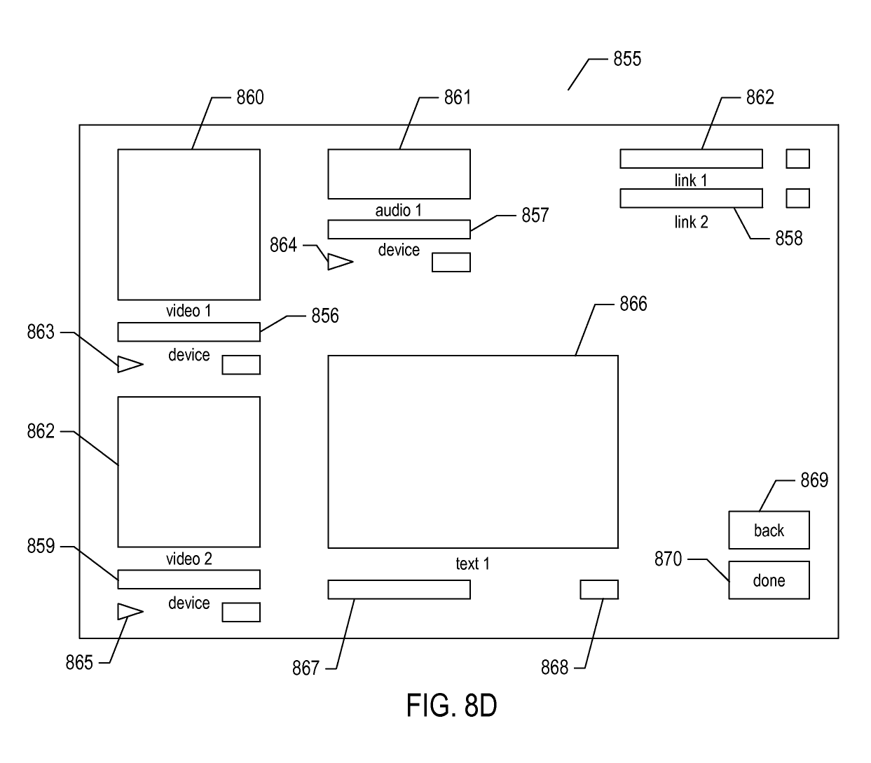

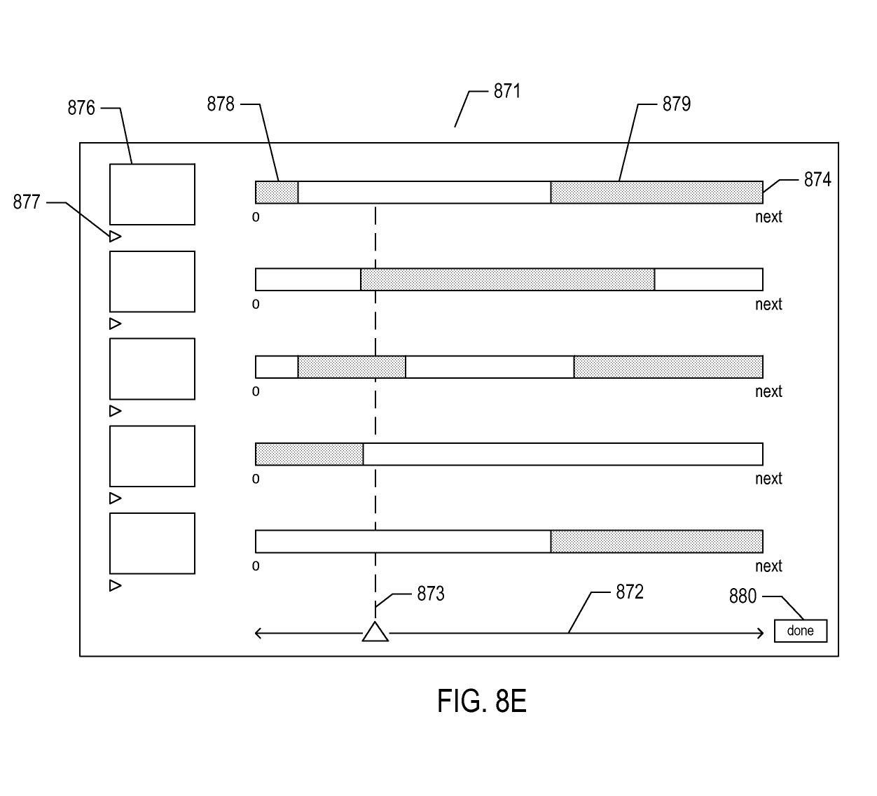

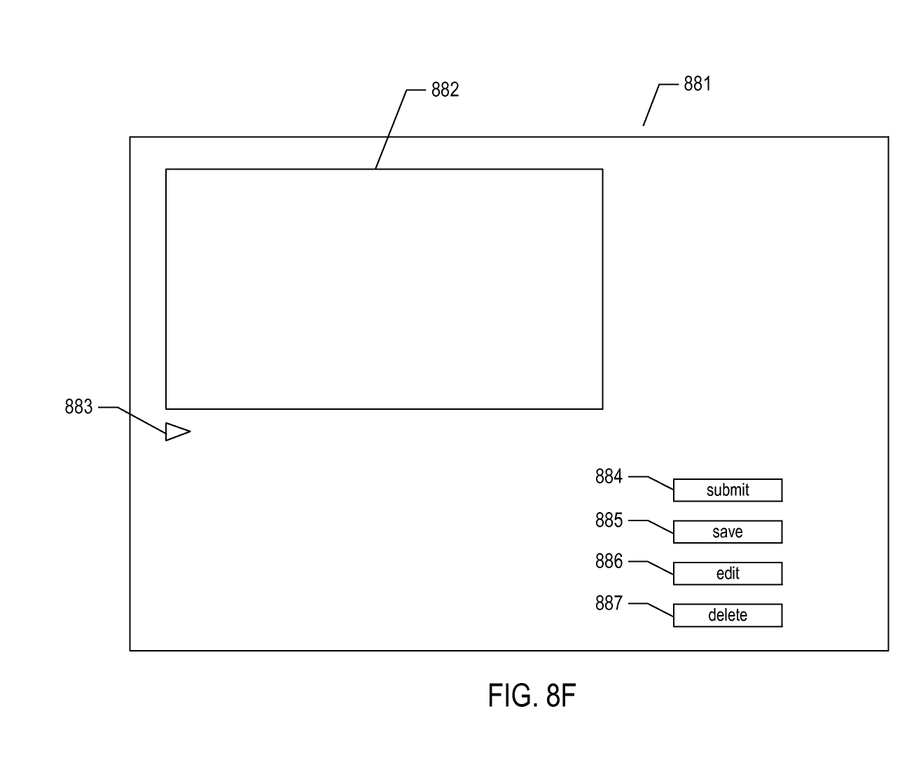

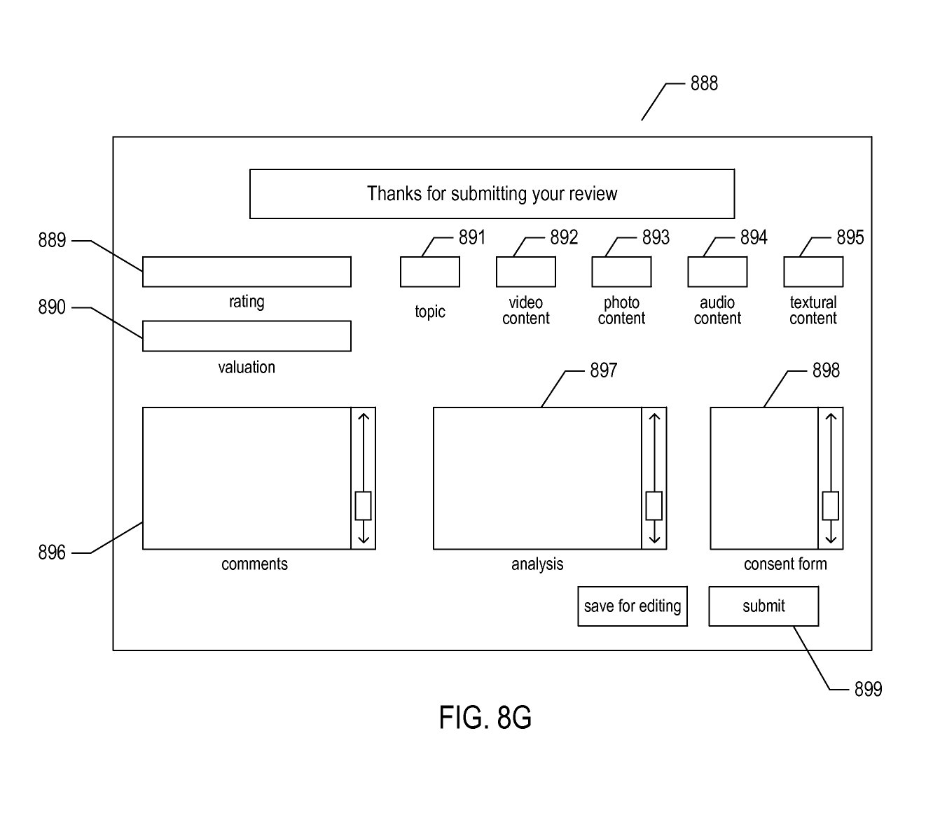

FIGS. 8A-G illustrate an example user interface provided by a client-side review-authoring and review-submission application. It should be emphasized that this example user interface is but one of many different possible user interfaces that may be provided by client-side applications. Alternative user interfaces may include a greater number or smaller number of features, different features, different numbers of display pages, and may use different types of display and input-entry features. The user interface shown in FIGS. 8A-F can be displayed by personal computers, laptops, and cell phones, while other types of user interfaces may be more appropriate for other types of electronic devices. Only a subset of the pages of the example user interface are shown in FIGS. 8A-G in order to provide a concise but general illustration of the client-side-application functionality provided to reviewers.

FIG. 8A shows an initial page displayed by the client-side application following launching of the client-side application. The initial page includes display of the name of the distributed review-aggregation system 802 with which the client-side application is communicating and additionally includes four input features 804-807. User input to the input features requests various operations supported by the distributed review-aggregation system that includes the client-side application, one or more aggregation servers, and other distributed computing facilities to support the one or more aggregation servers. When a user types a password into the password-entry feature 808 and clicks on the login feature 804, the client-side application interacts with an aggregation server to log the user into the distributed review-aggregation system. User input to the registration feature 805 allows a new user to register with the distributed review-aggregation system. User input to the help feature 806 launches a series of help displays, search features, and dialogs to allow a user to obtain information about the distributed review-aggregation system. User input to the requested-topics feature 807 fetches the current requested topics or a subset of the current requested topics from an aggregation server for display in a requested-topics-display window 809. A user may scroll up or down through the displayed topics in the requested-topics-display window 809 using scrolling features 810 and 811. The review-aggregator-name-display feature 802 may be static or, in certain implementations, may display multiple distributed review-aggregation systems, allowing a user to choose which of the multiple distributed review-aggregation systems with which to interact via client-side application. In these implementations, the client-side application supports interaction with multiple different review aggregators. In other implementations, the client-side application is a dedicated, proprietary application for a particular review aggregator. The requested-topics feature 807 and requested-topics-display window 809 furnish useful information to potential reviewers. The displayed requested topics represent those topics for which there is the greatest demand from retailers and other parties accessing the distributed review-aggregation system. In general, when reviewers are paid or reimbursed for submitting reviews, reviews related to these most desired topics generally result in the greatest payment or compensation and have the greatest chances of widespread distribution with subsequent downstream revenues. The registration feature 805 instructs the client-side application to collect information needed for a user profile that is submitted to, and stored within, the distributed review-aggregation system. Storage of reviewer profiles increases the efficiency of request/response exchanges between reviewers and the distributed review-aggregation system. The client-side application also provides reviewer-profile-editing facilities, in cooperation with an aggregation server, to allow reviewers to update their reviewer profiles.

FIG. 8B shows a high-level menu page displayed to a user who successfully logs into the distributed review-aggregation system via input of a valid password and input to the login feature 804 included in the initial page shown in FIG. 8A. The high-level menu page 812 includes command-input features 813-817, display-scrolling features 818-821, and navigation feature 822. User input to feature 813 results in display, in display window 823, of the names and/or identifiers (“IDs”) of reviews previously submitted by the reviewer to the distributed review-aggregation system. The reviewer may select one of these submissions by user input and launch an editing session by input to the edit-submission input feature 817. The similar input feature 814 and display window 824 allows a reviewer to review other reviewers' submissions. User input to new-submission input feature 815 begins a process for authoring and submitting a new review. User input to the edit-profile feature 816 allows a user to edit the contents of the user's reviewer profile. The ability of users, in the described implementation, to review other reviewer's submissions may assist a user in understanding how to create a useful and viable review and may allow a user to acquire new ideas and techniques for authoring reviews.

FIG. 8C illustrates a first page of a new-review-authoring dialog invoked by user input to the new-submission input feature 815 shown in FIG. 8B. The first page 825 of the review-authoring dialog includes a variety of input features to input metadata for a new product or service review. Only a few of the different types of input features that may be provided by the client-side application are shown on the example first review-authoring-dialog page 825 shown in FIG. 8C. A select-topic input feature 826, topic display window 827, display-window-scrolling features 828-829, other-topic-entry window 830, and other-topic-select input feature 831 allow a user to select one of a number of standard review topics provided by the distributed review-aggregation system to associate with the new review or to input a new topic for the review. Input features 832-836 allow a user to input the number of media objects of each of various different media types and to then input a mouse click or other user input to the media-type input feature 837 to store the numbers of the various different types of media objects to be included in the review. Input features and associated text-entry windows 838-842 and 843-848 allow a user to input various types of metadata for the new review, including the date created, the date that the user wishes the review to be available from, the date the user wishes the review to be available to, a location at which the review was created, and an indication of whether or not the user purchased the product or service with respect to which the review is created. A key-features input feature 849 and associated text-input window 850 allows a user to enter textural descriptions of various key features of the product or service and a criticisms input feature 851 and associated text-input window 852 allow a user to input various criticisms and disadvantages of the product or service being reviewed. Navigation feature 853 results in display of a next review-authoring page, described below with reference to FIG. 8D.

FIG. 8D shows a review-composition page accessed by a user via input to the compose input feature 853 shown in FIG. 8C. The review-composition page 855 includes text-input windows that allow a user to input specifications of a device and other media-object indications that allow the device on which the client-side application runs to download or receive streaming input of a media object from the device. Once a media object has been downloaded or streamed to the client-side application, the media objects can be played for review to the user using presentation features 860-862 with associated control features 863-865, for visual and audio media types. Textural components of reviews can be input to a text-entry window 866 via a keyboard associated with the device running the client-side application or may be downloaded using a file-specification-entry window 867 and fetch input feature 868. Presentation windows and specification-input windows are provided for each of the media objects entered through the media-type input feature 837 shown in FIG. 8C. Navigation features 869 and 870 allow a user to return to the previous page shown in FIG. 8C or advance to the timeline page shown in FIG. 8E and discussed below.

FIG. 8E illustrates a timeline page that allows users to specify time intervals at which media objects play with respect to an overall timeline for a multi-media review. The timeline page 871 includes an indication of the overall timeline 872 and a movable vertical bar 873 that can be moved by the user to any point along the timeline. The vertical bar is used to indicate a starting point or ending point for a particular interval. An individual timeline is provided for each media object in association with a small presentation window in which the media object can be played. For example, media-object timeline 874 is associated with presentation window 876 and input feature 877 and all of these features of the timeline page 871 are associated with video media object input via features 856 and displayed in display window 860 of the review-composition page 855 shown in FIG. 8D. In FIG. 8E, shading is used to indicate rendering intervals for each media object. For example, the first video media object is intended to be played during an initial time interval 878 and during a final time interval 879. Once a user has finished specifying play intervals for each media object, input to the navigation feature 880 results in display of a review page, next discussed with reference to FIG. 8F.

FIG. 8F shows a review page 881 that includes a large display or presentation window 882 that allows a user to review the multi-media product or service review that the user has composed via the previously discussed review-composition page 855 shown in FIG. 8D and the timeline page 871 shown in FIG. 8E. Input feature 883 allows a user to start and stop display of the multi-media review. In general, the review window includes multiple-windowing capabilities to allow multiple media objects to be concurrently rendered and displayed, according to the defined play intervals. Input features 884-887 allow the user to submit the multi-media review to the distributed review-aggregation system, save the multi-media review locally, continue editing the multi-media review, or delete the multi-media review.

FIG. 8G shows a feedback page displayed by the client-side application following response to submission of a review by the user to the distributed review-aggregation system. The feedback page 888 displays an overall rating 889 and valuation 890 for the submitted review as well as individual ratings 891-895 for the review topic and for each of the different media objects included in the review. In addition, comments and an analysis of the submitted review are displayed in display windows 896 and 897. Finally, a consent form or agreement is displayed in display window 898 which, when accepted by the user, acts as an agreement or contract for transfer of all or a portion of the rights of the review to the distributed review-aggregation system. The agreement is accepted by user input to the submit feature 899.

As mentioned above, there are many different possible user interfaces that can be provided by the client-side application components of a distributed review-aggregation system. In certain cases, a much more sophisticated review-authoring subsystem may be provided, allowing for editing the content of media objects, overlaying graphics onto displayed media objects, definition and population of subframes and subwindows within the overall review presentation, and many other such editing features. In general, however, the currently described user interface employs simple and basic composition tools with the assumption that the review will be processed and packaged by retailer purchasers for display on their websites or kiosks and/or processed and packaged by the distributed review-aggregation system for display to accessing entities. In other words, in the described implementation, a user provides the basic review content and sophisticated packaging, formatting, and presentation of the content is carried out either by the distributed review-aggregation system or by purchasers of the review. In very complex and highly functional implementations, a full suite of multi-media-production tools and applications may be bundled with the client-side application to allow sophisticated users to prepare production-level reviews for submission to the distributed review-aggregation system.

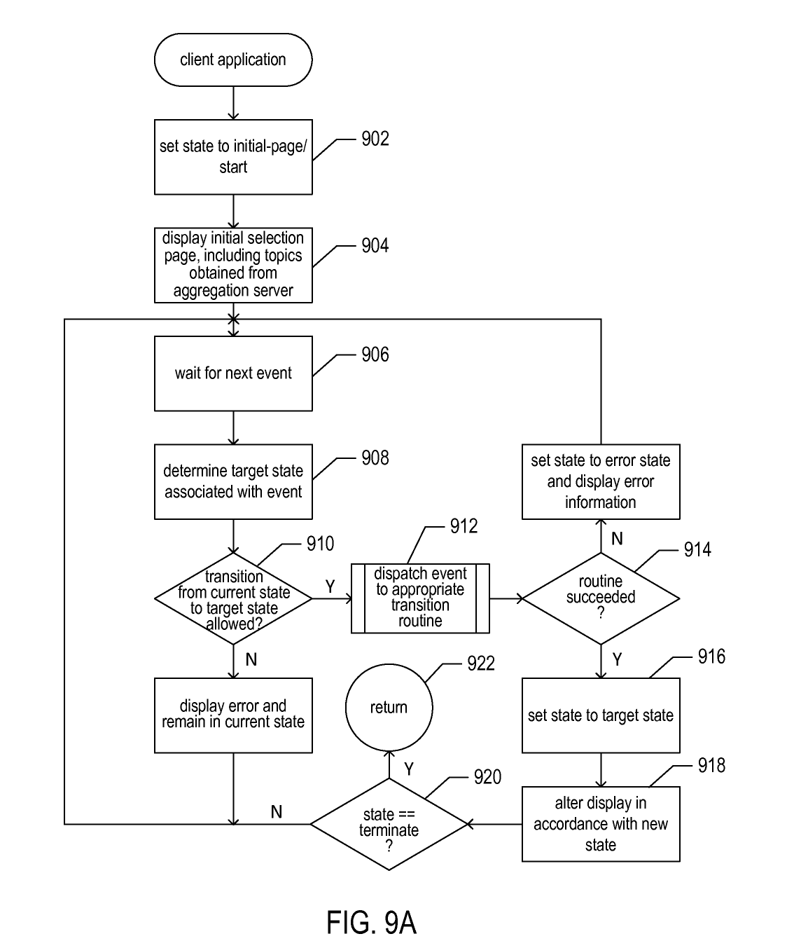

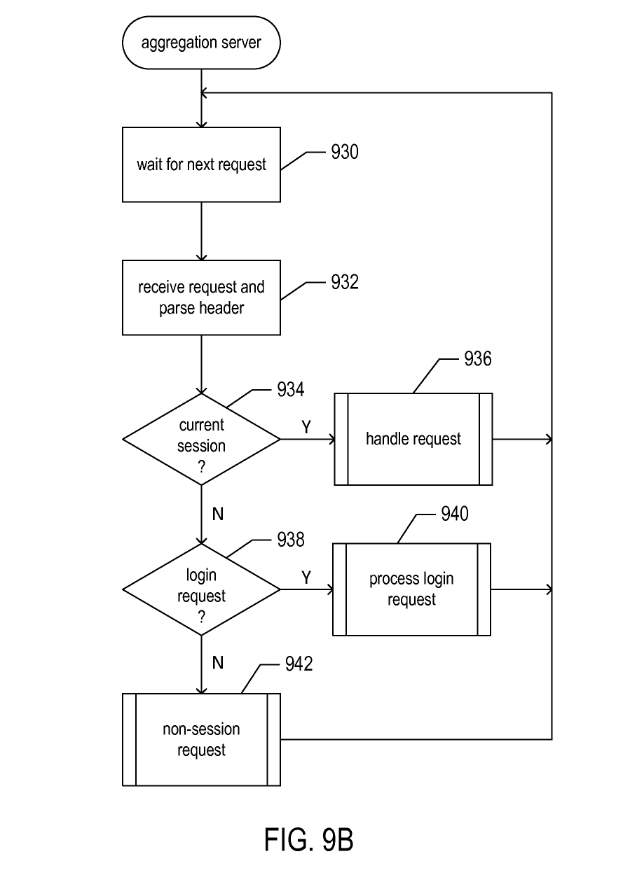

FIG. 9A-B provide general descriptions of the implementation of the client-side-application and aggregation-server components of the distributed review-aggregation system. FIG. 9A shows a control-flow diagram for the inner loop of the client-side application. In step 902, after being launched by a device operating system, the client-side application sets a current-state variable to indicate that the client application is in an initial-page/start state. In this implementation, the client application transitions from one state to another as events, including user inputs, occur. The overall state of the client application includes the currently displayed user-interface page and a local state relevant to the currently displayed page. Next, in step 904, the client application displays the initial page discussed above with reference to FIG. 8A. Then, in step 906, the client application waits for the occurrence of a next event. In general, events include user input and reception of communications messages transmitted by the aggregation server, but may include other types of events passed to the client application by the operating system. When a next event occurs, the client application determines a target state associated with the event, in step 908. When transition from the current state to the target state is allowed, as determined in step 910, then, in step 912, the client application dispatches the event to an appropriate event-handling/state-transition routine. When the routine succeeds, as determined in step 914, then the current state of the client application is set to the target state, in step 916 and, in step 918, the user-interface display may be altered in accordance with the state transition. When the current state is a terminate state, as determined in step 920, then the client application shuts down, as represented by the return statement 922. Otherwise, control returns to step 906 to wait for a next event. When the event-handling/transition routine fails, as determined in step 914, the current state of the client application is set to an error state and error information is displayed in the user interface followed by a return to step 906 to wait for a next event. When transition from the current state to the target state is not allowed, as determined in step 910, then an error is displayed, but the client-application remains in a current state and returns to step 906 to wait for a next event.

In practical implementations, the basic inner loop of the client application may be somewhat more complex, since events may occur at a higher rate than they can be handled. In general, events are queued according to priority for subsequent handling. Moreover, many state transitions may occur in response to a particular event before a return to the wait step 906. In certain implementations, the state of the client-side application may be implicit, rather than explicit.

FIG. 9B provides a control-flow diagram that illustrates the basic operation of the aggregation server. In step 930, the aggregation server waits for a next request. When a next request is received, the aggregation server, in step 932, receives the request from the operating system and parses a header included in the request message. When the request is a next request within the context of a current session, as determined in step 934, then the request is handled in step 936 in the context of that session. When the request is a login request, as determined in step 938, then the login request is processed in step 940, one effect of which is to create a session for the user requesting login. Other non-session-related and non-login requests, including registration requests and requests for help information, are processed in step 942. Thus, the aggregation server, in general, waits for and processes incoming requests on behalf of user-controlled remote client-side applications.

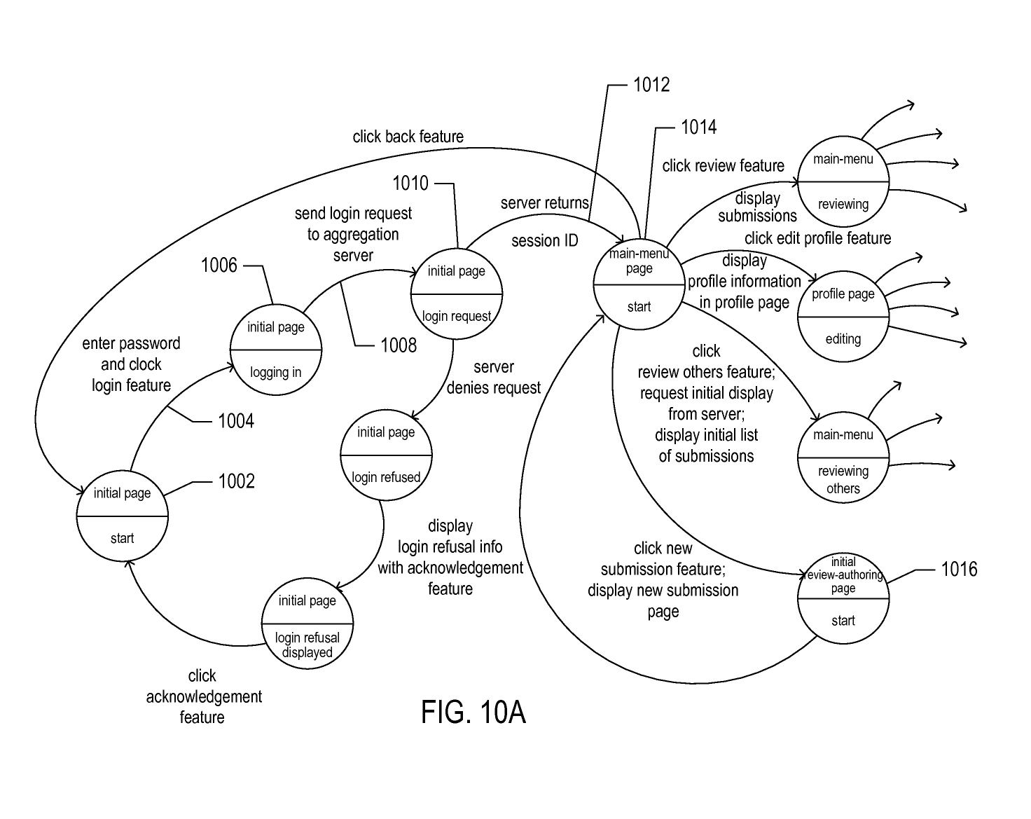

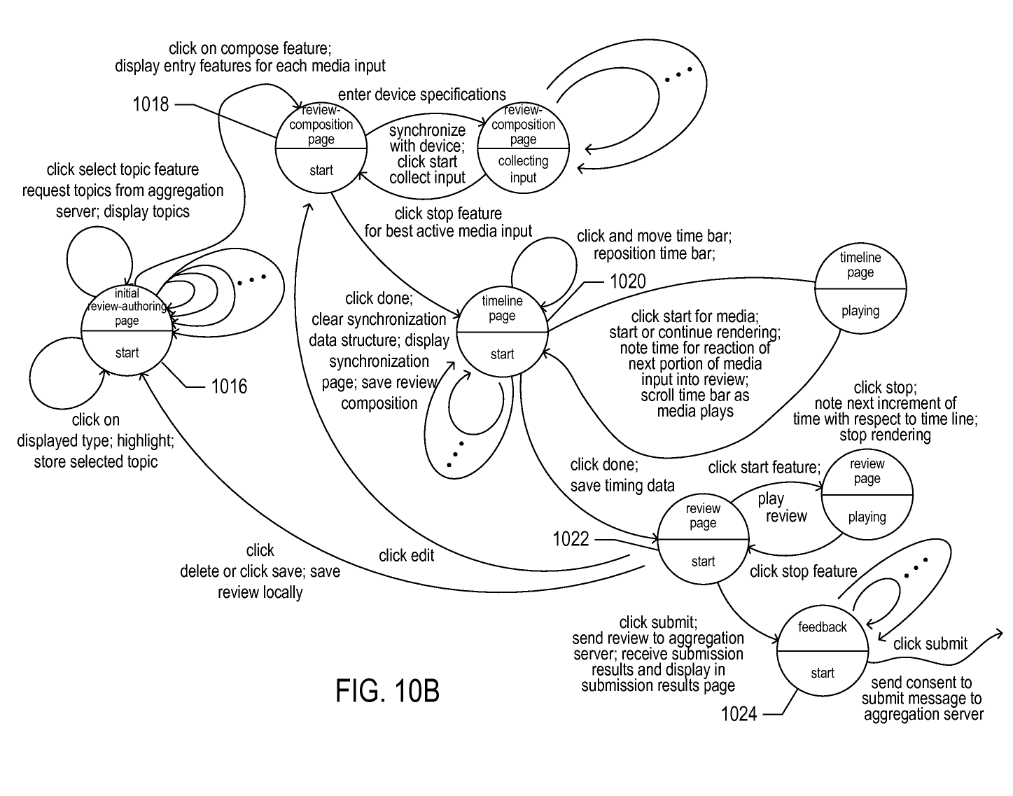

Practical implementations of the client-side application are, as with any large software system, generally complex and not amenable to brief descriptions, but instead comprise many modules and routines that, when executed by one or more processors, control a user device to display various different interface pages to the user, collect information and media objects from the user and the user's devices, and communicate with a remote aggregation server. One method for describing complex electronic systems, such as a user device controlled by the client-side application, is to use state-transition diagrams. FIGS. 10A-B provide a small portion of an example state-transition diagram for a client-side application component of a distributed review-aggregation system. Considering the portion of the state transition diagram shown in FIG. 10A, states are represented by disk-shaped nodes, such as disk-shaped node 1002 and transitions are represented as curved arcs that emanate from one node and lead to another node, such as arc 1004 that leads from node 1002 to node 1006. Each node includes an indication of the currently displayed user-interface page and a local state relevant to that page. For example, node 1002 indicates that the initial page, discussed above with reference to FIG. 8A, is currently displayed and that the client-side application currently resides in a local start state relevant to that initial page. State transitions are generally caused by events, including user input, received communications messages, and other events passed to the client-side application by the operating system. For example, when a user enters a password into the password-input feature 808 shown in FIG. 8A and inputs a mouse click to the login feature 804 shown in FIG. 8A, a transition represented by arc 1004 occurs to the state represented by node 1006, in which the client-side application constructs a login-request message. The transition represented by arc 1008 occurs when the client-side application sends the login request message to an aggregation server, with the client-side application then residing in a state represented by node 1010 in which the login request has been made and the client-side application waits for the aggregation server to return a response to the request. When the login succeeds, and the aggregation server returns a session ID in a response message to the client-side application, represented by transition 1012, then the client-side application displays the main-menu page, discussed above with reference to FIG. 8C, and inhabits a state represented by node 1014. Additional nodes in the partial state-transition diagram shown in FIGS. 10A-B include nodes representing an initial state after display of the initial review-authoring page 1016, discussed above with reference to FIG. 8C, an initial state following display of the review-composition page, discussed above with reference to FIG. 8D, represented by node 1018, an initial state following display of the timeline page, discussed above with reference to FIG. 8E, represented by node 1020, an initial state following display of the review page, discussed above with reference to FIG. 8F, represented by node 1022, and an initial state following the display of the feedback page, discussed above with reference to FIG. 8G, represented by node 1024. Of course, in a practical implementation of the distributed review-aggregation system, the state-transition diagram for the client-side application contains many more states and state transitions, just as the user interface contains many pages in addition to the pages discussed above with reference to FIGS. 8A-G. For example, once a user submits a review for distribution to retailers and other entities, via input to the submit input feature shown in FIG. 8G, additional pages may be displayed to the user to indicate acceptance by the distributed review-aggregation system and to transfer payment or credits to the user in return for the review. Additional pages and facilities may be provided by the client-side application to allow a user to monitor and receive additional payments following purchase or renting of reviews by retailers and other entities once the reviews are published by the distributed review-aggregation system.

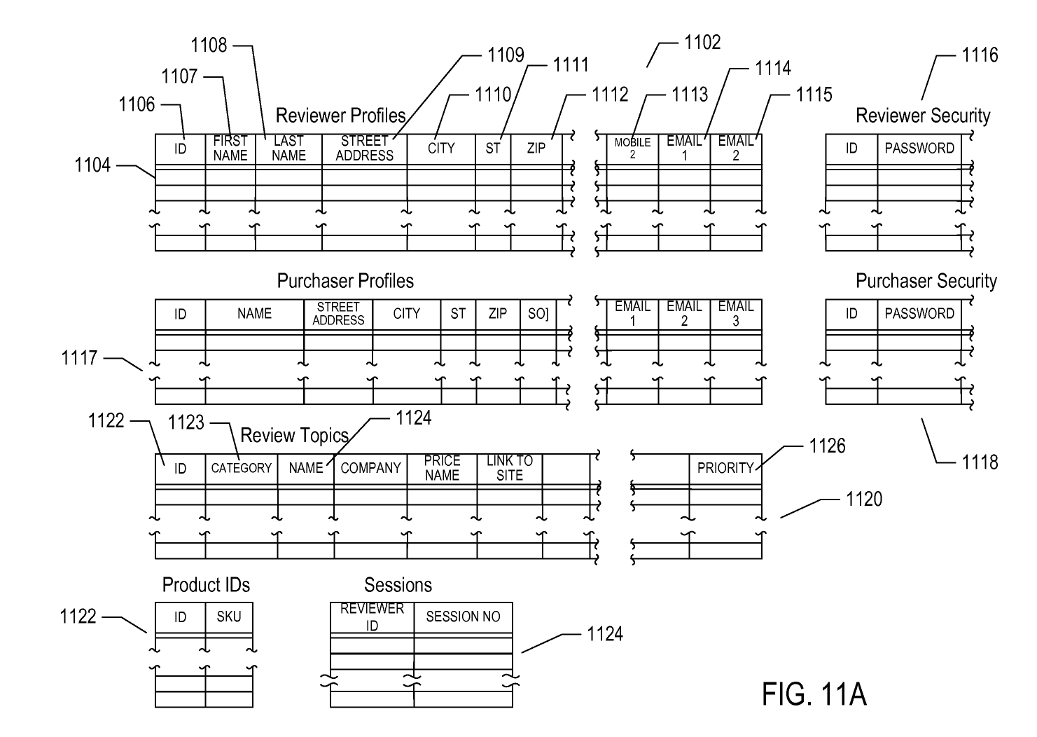

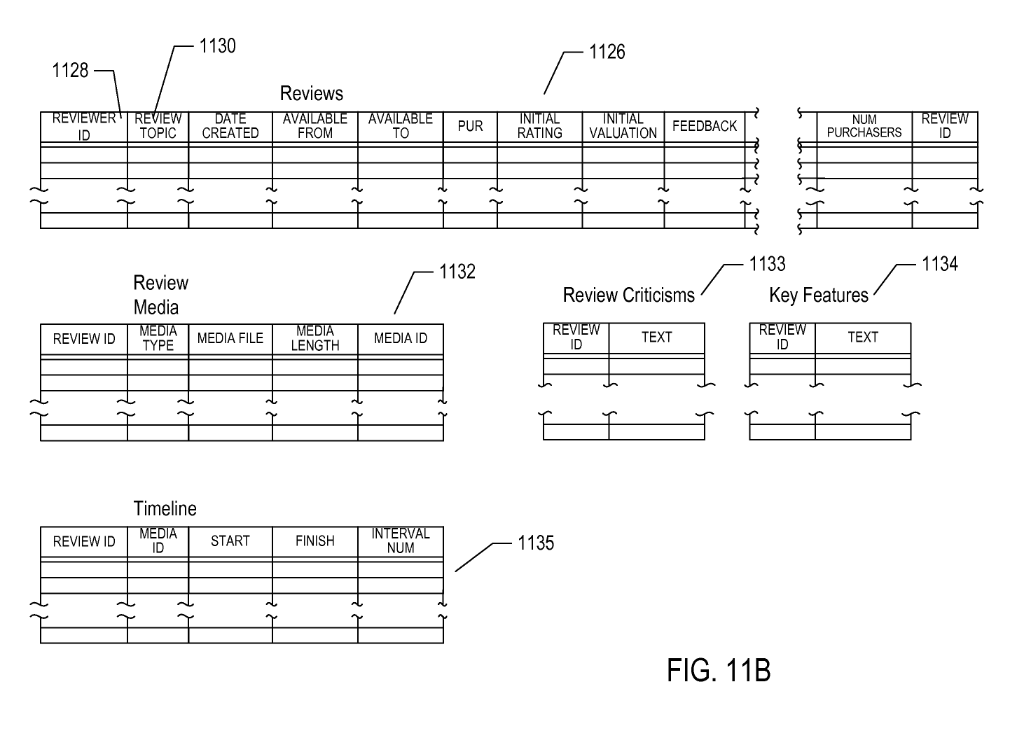

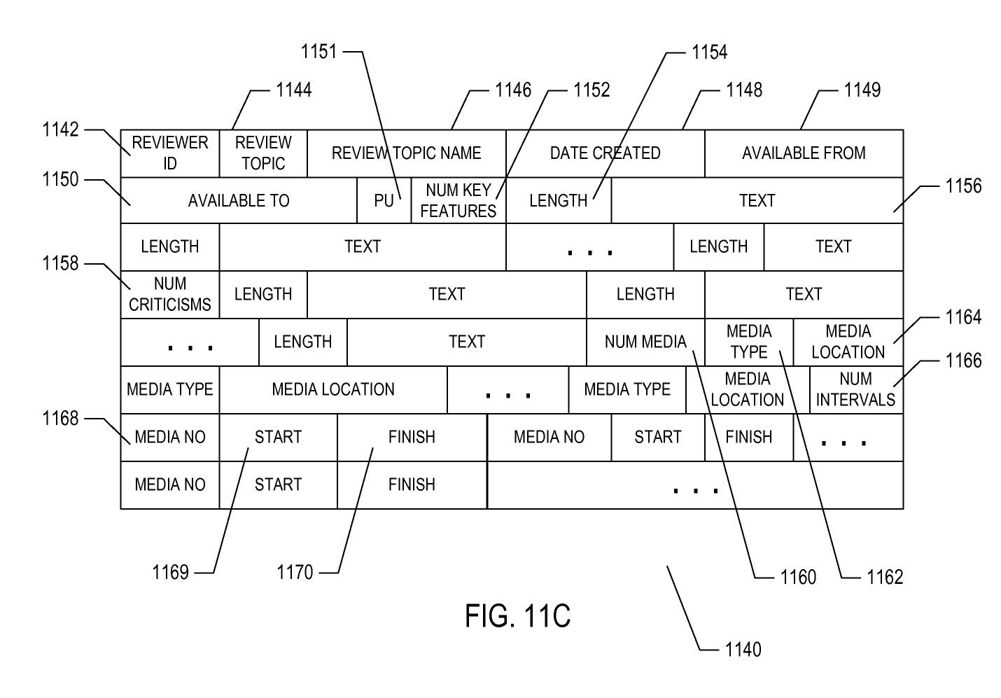

There are many different possible ways to implement the aggregation servers, just as there are many different possible implementations of the client-side application. In one implementation, the aggregation server stores reviews and reviewer profiles in relational database tables. FIGS. 11A-B illustrate a portion of the relational database tables that may be constructed and used by certain implementations of the aggregation server. A reviewer-profiles table 1102 may be used to store information about reviewers. Each row in the table, such as the first row 1104, includes the information for a particular reviewer. The columns of the table correspond to fields within an entry or record for a particular reviewer. In FIGS. 11A-B, only a few of the fields are shown from many of the tables, in the interest of brevity and clarity of illustration. A reviewer may be described by a unique reviewer ID 1106, first and last names 1107-1108, a street address 1109, city of residence 1110, state of residence 1111, zip code 1112, a mobile phone number 1113, a first email address 1114 and a second email address 1115. A separate reviewer-security table 1116 may store passwords for each reviewer represented by a reviewer ID. A purchaser-profiles table 1117 and purchaser-security table 1118 store similar information for retailers and other clients of the distributed review-aggregation system. Information about review topics is a stored in a review-topics table 1120. The information may include a unique ID for the review topic 1122, a category 1123 for the review topic, a name for the review topic 1124, and additional information, including a priority 1126 associated with the review topic. Higher-priority review topics are those review topics for which there is a large demand from retailers and other entities accessing the distributed review-aggregation system. A separate table 1122 may store codes for products corresponding to review topics and another table 1124 may store session numbers for currently accessing reviewers. A reviews table 1126, shown in FIG. 11B, includes entries that represent reviews submitted by reviewers. Fields within an entry of record describing a review include the reviewer ID of the reviewer submitting the review 1128, the topic of the review 1130, and other such information collected through the review-authoring pages discussed above with reference to FIG. 8C. In addition, separate tables 1132-1135 store descriptions of the media objects included in each review, review criticisms and key features associated with the review, and intervals for media objects with respect to a timeline for the review.

FIG. 11C shows a representation of a multi-media-review-package data structure transferred from the client-side application to the aggregation server when a review is submitted by a reviewer to the distributed review-aggregation system. The multi-media-review-package data structure 1140 includes the identifier for the reviewer 1142, an encoding of the review topic 1144, the review-topic name 1146, additional metadata associated with the review 1149-1151, one or more key features, the number of which is indicated by the value in field 1152, with each key feature represented by a length 1154 and a following text string of that length 1156. Similarly, criticisms associated with the review are included in a list of criticisms that begin with a number of criticisms 1158. Field 1160 indicates the number of media objects included in the review. Each media object is represented by an indication of the media type 1162 and an indication of an address or location from which the media object can be downloaded or streamed 1164. Finally, field 1166 indicates the number of timeline intervals specified by the user, with each interval represented by an indication of the media object 1168, a start time 1169, and a finish time 1170. As with the above-described relational-database tables, user-interface pages, and state-transition diagrams, a particular implementation of the multi-media-review-package data structure may include many additional fields representing additional types of metadata and additional data related to media objects.

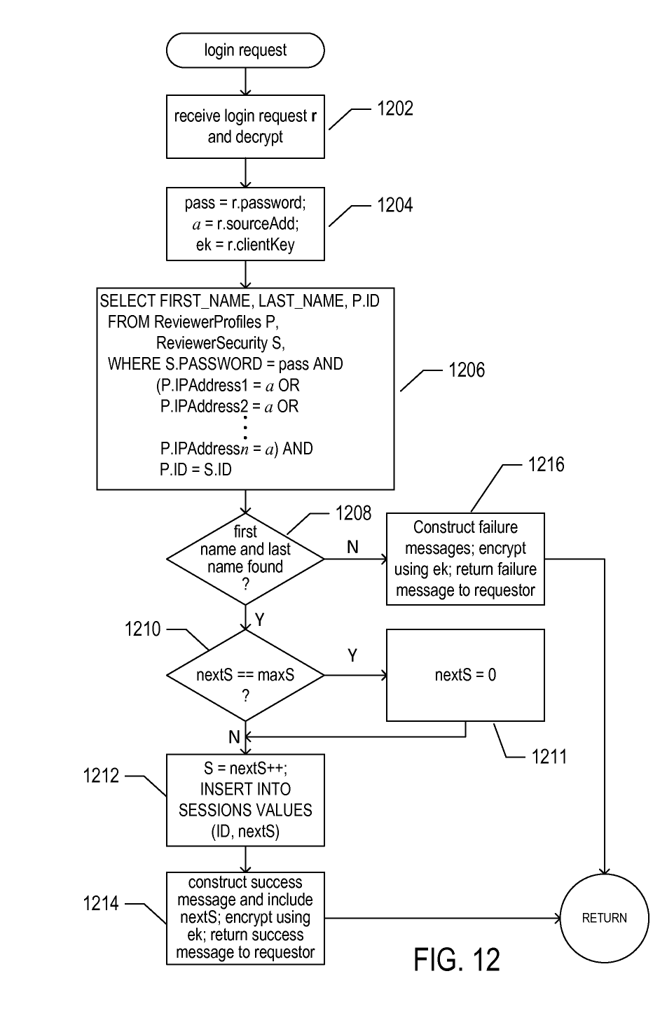

FIGS. 12-16 illustrate, using control-flow diagrams, aggregation-server handling of various types of requests. FIG. 12 illustrates handling of a login request received by an aggregation server. In step 1202, the aggregation server receives the login request and decrypts the contents of the request using the aggregation server's private key of a public/private key pair. In step 1204, the aggregation server extracts a password, source address, and client key from the login-request message. In step 1206, the aggregation server attempts to find an entry for the requesting user in the reviewer-profiles table and a matching password in the reviewer-security table. When an entry is found, as determined in step 1208, then, in steps 1210-1212, the aggregation server generates a new session ID or session number for the user and inserts the new session number into the sessions table. In step 1214, the aggregation server constructs a success message with which to respond to the login request, the success message including a session number generated for the user and, in certain implementations, the reviewer ID associated with the user, encrypts the success message using the client's key extracted from the login-request message, and returns the success message to the requestor. When an appropriate entry cannot be found in the reviewer-profiles table and reviewer-security table for the login request, a failure message is constructed, in step 1216, and returned to the client-side application from which the login-request message was received.

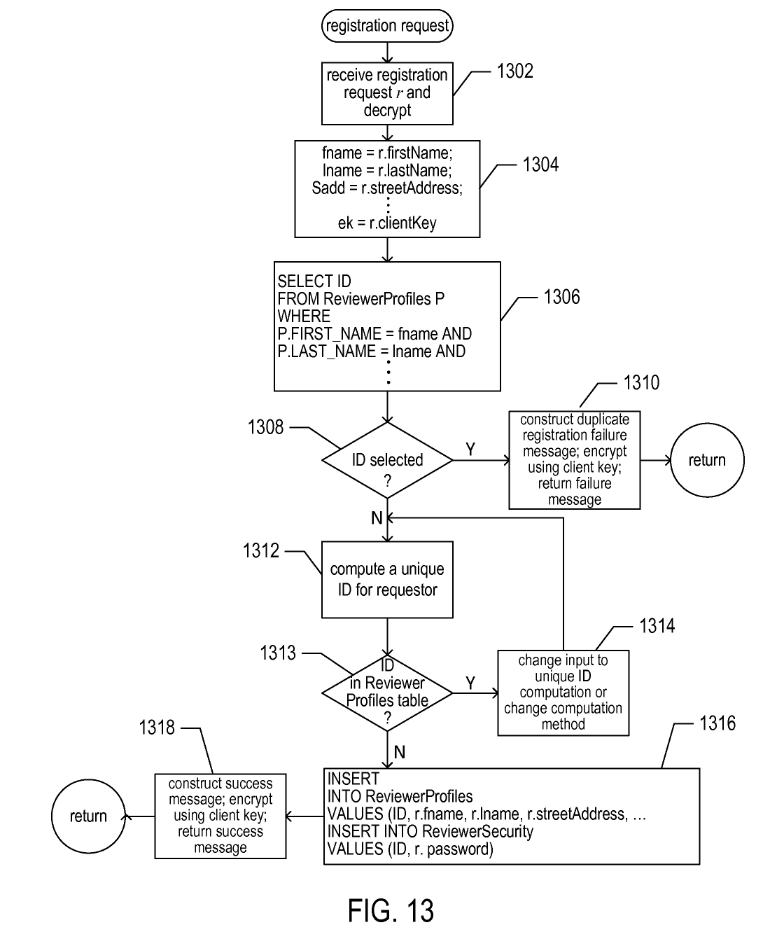

FIG. 13 provides a control-flow diagram that illustrates handling of a registration request by the aggregation server. In step 1302, the aggregation server receives a registration-request message and decrypts the message using the aggregation server's private key. In step 1304, the aggregation server extracts various types of profile information included in the registration-request message as well as a client key from the received registration-request message. In step 1306, the aggregation server attempts to find a matching profile already resident within the reviewer-profiles table. When a matching entry is found, as determined in step 1308, then the aggregation server constructs a duplicate-registration-failure message, in step 1310, and returns the failure message to the client-side application from which the registration-request message was received. Otherwise, the aggregation server computes a new unique reviewer ID for the user in step 1312-1314. In step 1316, the aggregation server inserts information for the user into the reviewer-profiles table and reviewer-security table. Finally, in step 1318, the aggregation server constructs a success-message to return to the client-side application in response to this received registration-request message.

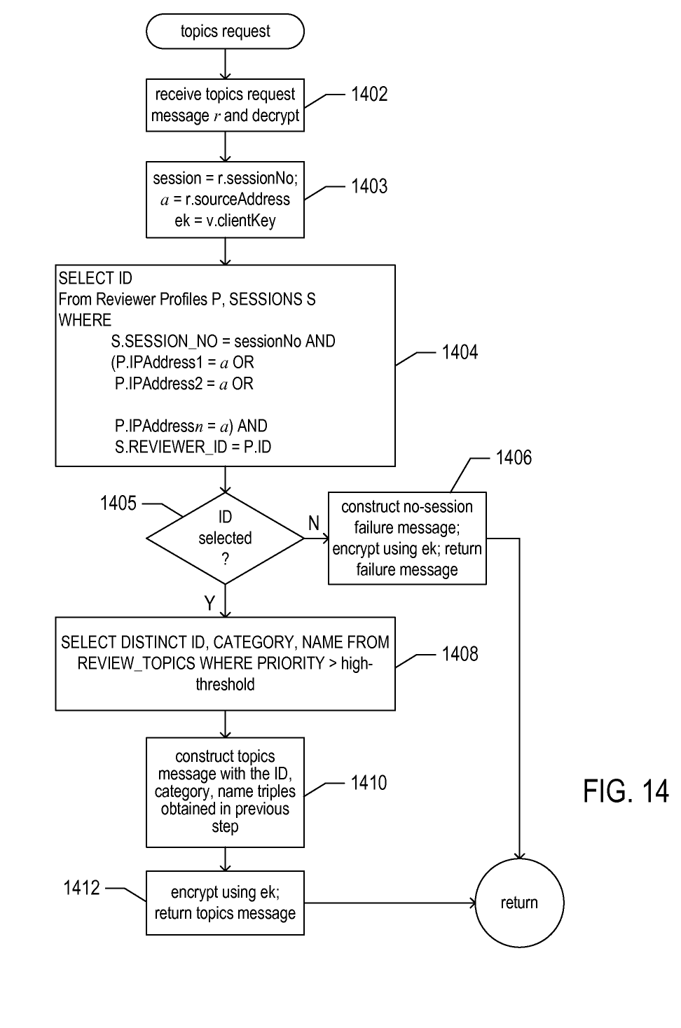

FIG. 14 provides a control-flow diagram for handling of a topics request by an aggregation server. In steps 1402-1405, the aggregation server receives the topics request and determines whether or not the requesting user is currently logged in and is making the request in the context of the current session. When there is no session or profile entry for the user, then, in step 1406, the aggregation server constructs a no-session failure message and returns it to the requesting client-side application. Otherwise, the aggregation server retrieves a list of metadata-description of the highest-priority review topics from the review-topics table, in step 1408 and returns the retrieved topics in a topics message constructed in step 1410 and encrypted in step 1412.

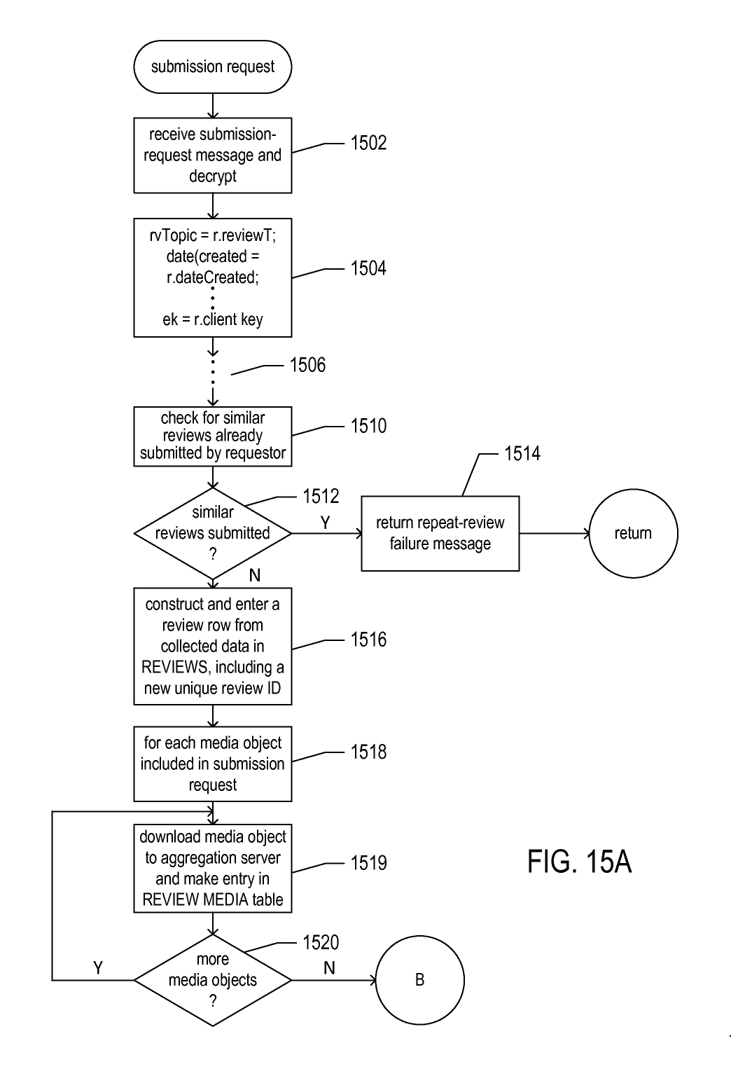

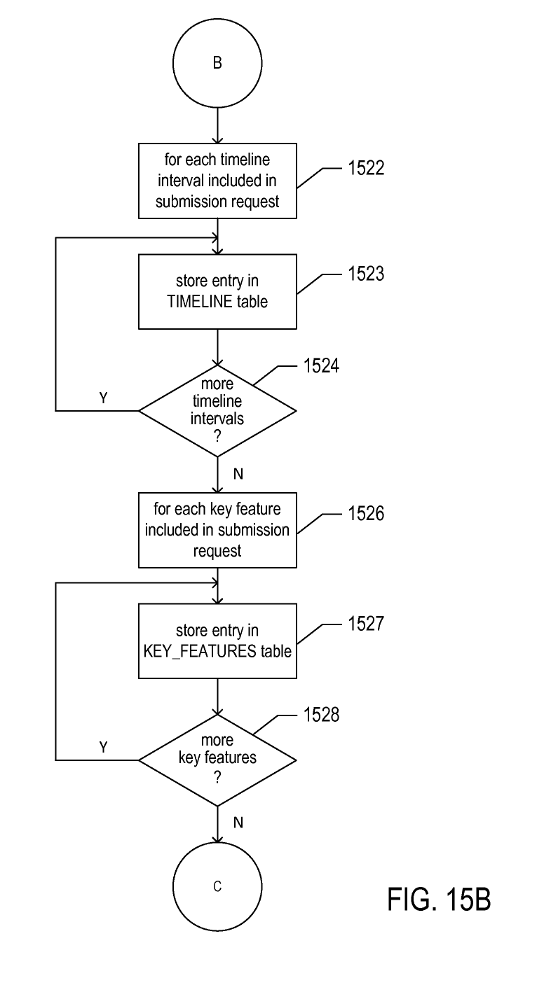

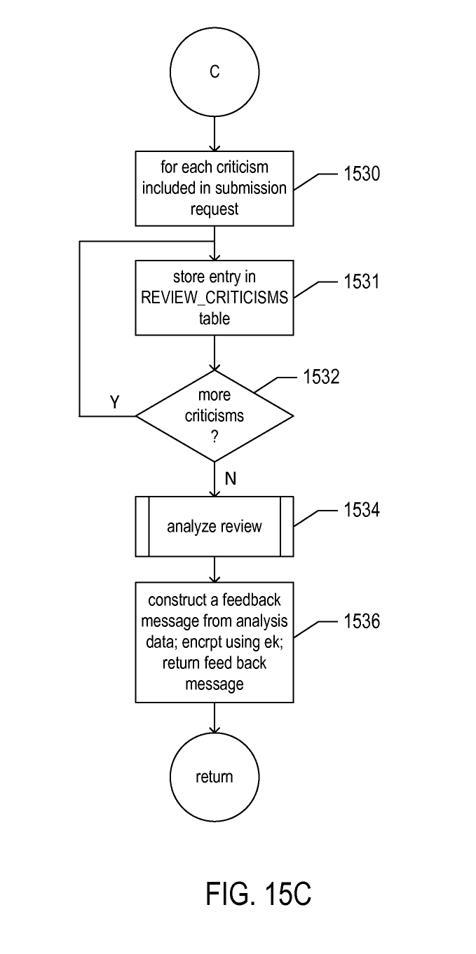

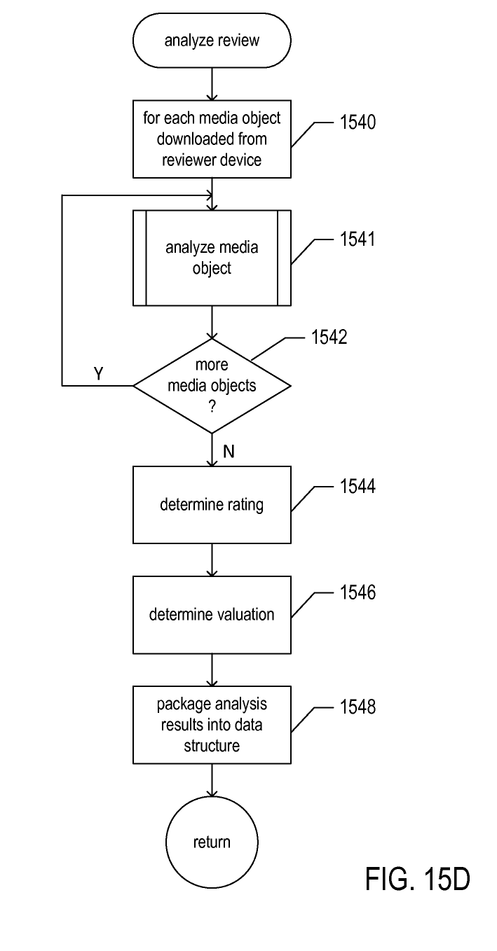

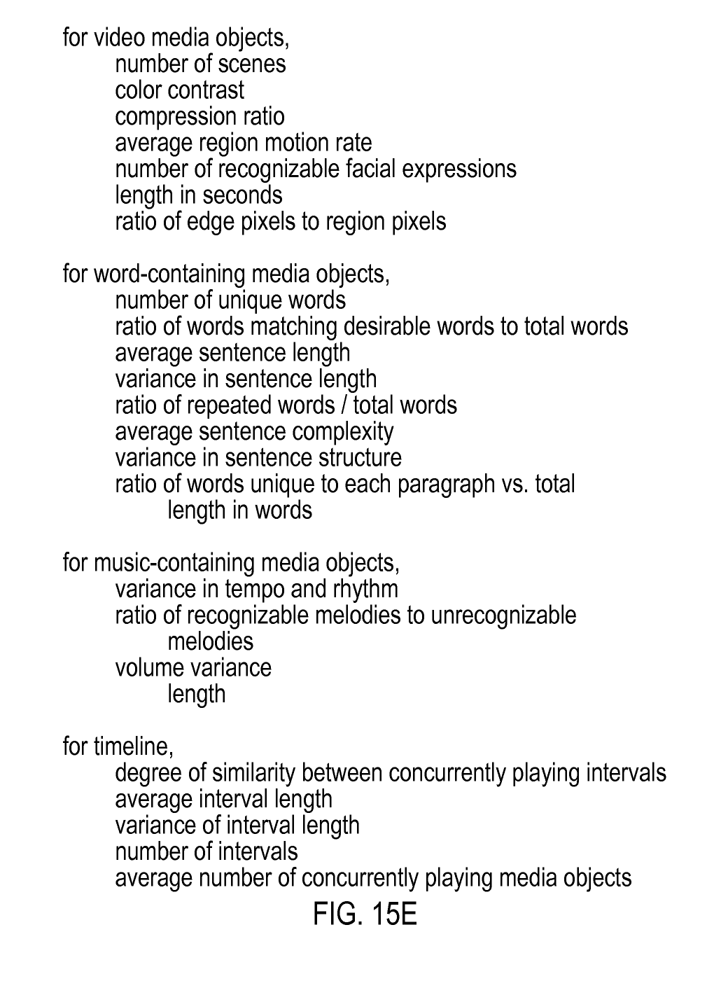

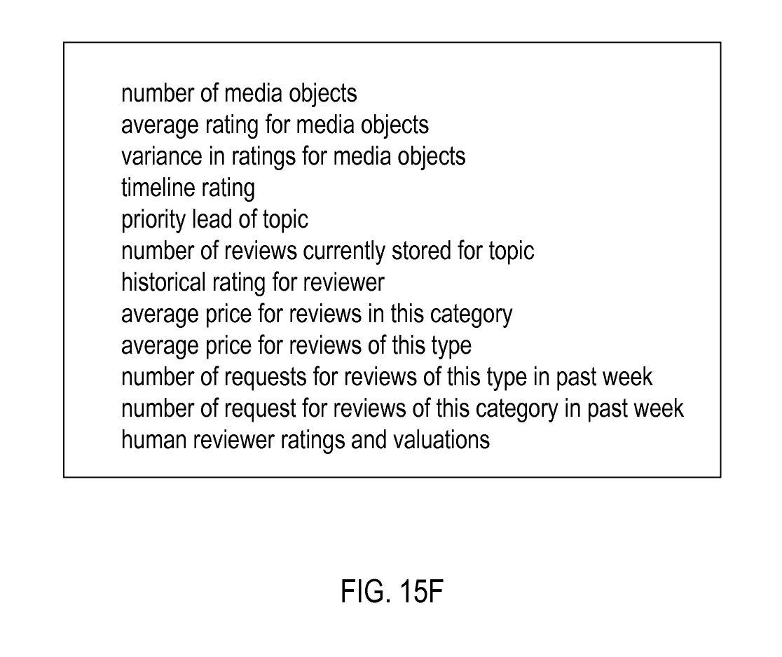

In FIGS. 15A-D, a control-flow diagram for handling of a review-submission request by the aggregation server is provided. In step 1502 in FIG. 15A, the aggregation server receives a submission-request message and decrypts the message. In step 1504, the aggregation server extracts metadata from the multi-media-review-package data structure included in the submission-request message as well as a client key. In additional steps represented by ellipsis 1506, the aggregation server determines whether or not the submission-request message has been sent in the context of an active session. When not, a failure message is returned. These steps are similar to steps 1404-1406 in FIG. 14. Next, in step 1510, the aggregation server checks for similar reviews already submitted by the requester residing in the reviews table. This can be carried out by a query that partially matches metadata information extracted from the submission-request message in step 1504 to data contained in entries of the review table. When one or more similar reviews have already been submitted, as determined in step 1512, then the aggregation server returns a repeat-review-failure message in step 1514. Otherwise, the aggregation server generates a new unique review ID for the submitted review and constructs an entry for the submitted review in the reviews table using extracted information, in step 1516. In the for-loop of steps 1518-1520, the aggregation server downloads or streams each media object described in the multi-media-review-package data structure, locally stores the media object, and enters an entry into the review-media table describing the media object. Similarly, in steps 1522-1524 shown in FIG. 15B, timeline intervals specified in the multi-media-review-package data structure are extracted and corresponding entries are stored in the timeline table. In the for-loop of steps 1526-1528, key features included in the multi-media-review-package data structure are extracted and stored in the key-features table. In the for-loop of steps 1530-1532 shown in FIG. 15C, criticisms included in the multi-media-review-package data structure are extracted and stored in the review-criticisms table. In step 1534, the aggregation server analyzes the submitted review and, in step 1536, constructs a feedback message containing data from the analysis that is display to the submitting reviewer by the client-side application in the feedback page discussed above with reference to FIG. 8F.

FIG. 15D provides a control-flow diagram for the routine “analyze review,” called in step 1534 of FIG. 15C. In the for-loop of steps 1540-1542, the routine “analyze review” analyzes each media object in order to determine a rating for each of the media objects. In step 1544, the routine “analyze review” determines an overall rating for the submitted review which may include separate, component ratings for the review topic and other aspects of the review. In step 1546, the routine “analyze review” determines an initial valuation for the submitted review. Finally, in step 1548, the routine “analyze review” packages the results of analyzing the individual media objects and the submitted review as a whole into a data structure that is returned to the client-side application that submitted the review.

In general, analysis of a submitted review and the media objects contained in the submitted review may involve computation of many intermediate values and combining these intermediate values, often with weight multipliers, to produce a final numerical rating. The intermediate values may also generate natural-language comments and analyses that may be included in feedback returned to a user in response to submission of a review. FIG. 15E lists a number of the different intermediate values that may be computed during analysis of particular media objects and the timeline intervals that describe how playback of the media objects are synchronized. Many of these intermediate values can be generated by computational analysis of submitted media objects. For example, for video media objects, video-analysis modules may determine the number of discrete scenes included in the video, compute numeric values that reflect the amount of color contrast in each of the scenes and in the video, in general, compute a compression ratio for the video object, which is indicative of the information content of the video, the average rate of motion of discrete regions within the video scenes by computing motion vectors for the regions, a number of recognizable different facial expressions exhibited by people in the video, the length of the video in seconds, and the ratio of edge pixels to region pixels within the video. Many other such computed values and metrics can be automatically generated by video-analysis modules. In combination, these values may be used to estimate the information content of the video, the likely appeal of the video to viewers of the video, and other such higher-level characteristics that can be combined together to produce an overall numerical rating value. FIG. 15E shows various additional examples of metrics that may be computed for word-containing media objects, such as text files, music-containing media objects, and for the timeline intervals that describe when media objects are displayed or presented during the review.

FIG. 15F shows various different types of intermediate results that may be computed in order to determine an overall rating for a review as well as a valuation for the review. As with the ratings determined for individual media objects, the rating and valuation for the review, as a whole, is generally based on a weighted combination of many such lower-level numerically represented characteristics and considerations. In certain implementations, ratings may be provided by human review analysts in addition to computational processing of submitted reviews. In some implementations ratings may be provided by retailers and other clients of the distributed review-aggregation system, as well as customers, viewing the review on the retailer's system.

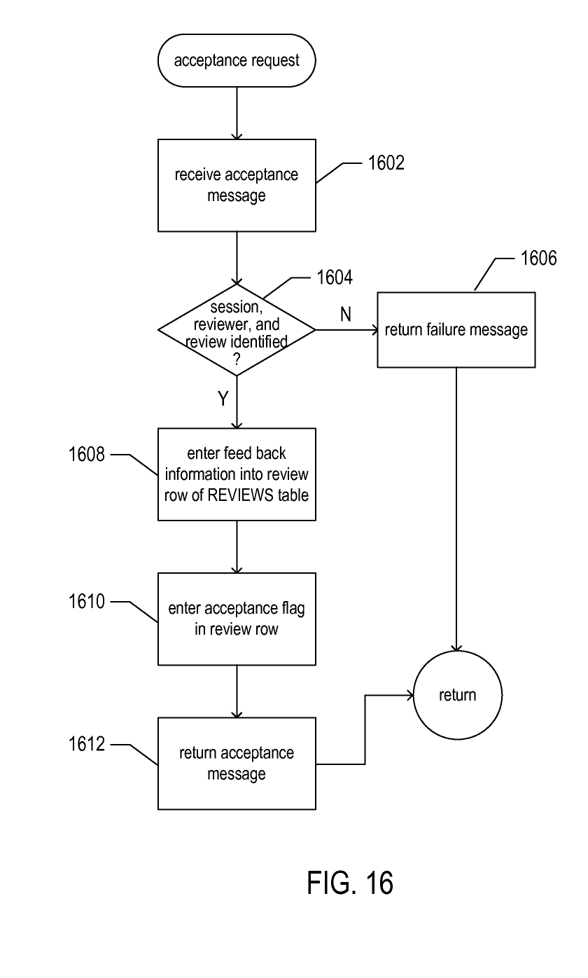

FIG. 16 provides a control-flow diagram for a routine that handles final acceptance or submission requests generated as a result of user input to the submit input feature shown in FIG. 8G. In step 1602, the aggregation server receives an acceptance or a final submission message from a client-side application. The aggregation server then verifies that this message includes identification of a current session, the reviewer interacting with the distributed review-aggregation system via the session, and an identifier for a submitted review. When this cannot be verified, as determined in step 1604, then a failure message is returned to the client-side application in step 1606. Otherwise, the feedback information provided to the reviewer in a previously sent message is inserted into the row of the reviews table representing the submitted review, in step 1608. Then, an acceptance flag is set for the review in step 1610, with the acceptance flag corresponding to a column in the reviews table. Finally, in step 1612, an acceptance acknowledgement message is returned to the client-side application. Subsequently, the server aggregator may, in a separate transaction, transmit credits or other remuneration to the reviewer in return for the right to distribute the review to retailers and other interested parties.

Although the present invention has been described in terms of particular embodiments, it is not intended that the invention be limited to these embodiments. Modifications within the spirit of the invention will be apparent to those skilled in the art. For example, any of many different possible implementations can be obtained by varying one or more of many different implementation and design parameters, including modular organization, underlying hardware platform and operating system, control structures, data structures, programming language, and other such parameters. As discussed above, many different client-side-application-provided user interfaces may be designed and implemented, and the aggregation servers may support handling of many additional types of requests. By providing standardized reviews of submitted reviews, the distributed review-aggregation system operates to increase the usefulness and appeal of the reviews offered by the distributed review-aggregation system to retailers and other interested parties. By aggregating reviews from potentially large numbers of reviewers, the distributed review-aggregation system provides single-source advantages to purchasers of reviews and volume-distribution advantages to reviewers who submit reviews to the distributed review-aggregation system.

It is appreciated that the previous description of the disclosed embodiments is provided to enable any person skilled in the art to make or use the present disclosure. Various modifications to these embodiments will be readily apparent to those skilled in the art, and the generic principles defined herein may be applied to other embodiments without departing from the spirit or scope of the disclosure. Thus, the present disclosure is not intended to be limited to the embodiments shown herein but is to be accorded the widest scope consistent with the principles and novel features disclosed herein.

1. A distributed review-aggregation system comprising:
one or more processor-controlled devices controlled by a client-side application to collect media objects from user devices, compose a multi-media review from the collected media objects, and submit the multi-media review to a remote aggregation server; and
the remote aggregation server, the remote aggregation server including one or more memories, one or more processors, and processor instructions stored in one or more of the one or more memories that, when executed by one or more of the one or more processors, control the remote aggregation server to
receive the submitted multi-media review,
store the multi-media review in one or more data-storage devices, and
provide access to the stored multi-media review by a retailer's computer system or a computer system of another type of review-accessing entity.

2. The distributed review-aggregation system of claim 1 wherein the distributed review-aggregation system includes multiple aggregation servers provided by one or more cloud-computing facilities or by one or more private data centers.

3. The distributed review-aggregation system of claim 1 wherein the client-side application controls the one or more reviewer devices to submit the multi-media review to the remote aggregation server as a multi-media-review-package data structure that includes metadata fields and descriptions of each media object included in the review.

4. The distributed review-aggregation system of claim 3 wherein the description of each media object includes information that the remote aggregation server extracts and uses to download the media object or stream the media object to the remote aggregation server or to a remote storage device.

5. The distributed review-aggregation system of claim 1 wherein, in response to receiving the multi-media review submitted by the client-side application, the remote aggregation server analyzes the multi-media review to produce an overall rating and returns the overall rating to the client-side application for display to a reviewer.

6. The distributed review-aggregation system of claim 5 wherein, in addition to the overall rating, the distributed review-aggregation system analyzes the multi-media review to produce an initial valuation and a rating for each media object included in the multi-media review which are returned, in addition to the overall rating, to the client-side application for display to the reviewer.

7. The distributed review-aggregation system of claim 5 wherein the overall rating comprises one or more ratings from the retailer.

8. The distributed review-aggregation system of claim 5 wherein the overall rating comprises one or more ratings from a user viewing the review using the retailer's system.

9. The distributed review-aggregation system of claim 1 wherein, in response to receiving a login request from the client-side application generated on behalf of a reviewer, the remote aggregation server
determines whether or not the reviewer is associated with a reviewer profile, and
when the reviewer is associated with a reviewer profile, generates a session ID to represent a session context and returns the session IS to the client-side application.

10. The distributed review-aggregation system of claim 1 wherein, in response to receiving a registration request from the client-side application generated on behalf of a reviewer, the remote aggregation server
determines whether or not the reviewer is associated with a reviewer profile, and
when the reviewer is not already associated with a reviewer profile, generates a reviewer profile for the reviewer using profile data included in the registration request and returns an acknowledgement message to the client-side application.

11. The distributed review-aggregation system of claim 1 wherein, in response to receiving a request for review topics from the client-side application generated on behalf of a reviewer, the remote aggregation server
generates a list of review topics by extracting review topics associated with priorities greater than a threshold priority from a storage device, and
returns the list of review topics to the client-side application.

12. The distributed review-aggregation system of claim 1 wherein, in response to receiving a request from the client-side application generated on behalf of a reviewer to accept the submitted review in accordance with an agreement displayed to the reviewer by the client-side application, the remote aggregation server
stores an indication in a data storage device that the review has been finally submitted and is ready for publishing and distribution.

13. A distributed review-aggregation system comprising:
a remote aggregation server that includes one or more memories and one or more processors, the remote aggregation server storing data in one or more data storage devices, receiving requests, and responding to the requests;
one or more processor-controlled devices controlled by a client-side application, the one or more processor-controlled devices including one or more memories, one or more processors, and processor instructions stored in one or more of the one or more memories and, in part, implementing the client-side application, that, when executed by one or more of the one or more processors, control the one or more processor-controlled devices to
display a user interface to a reviewer,
receive inputs from the reviewer that direct the client-side application to compose a multi-media review that includes media objects downloaded or streamed from one or more user devices, and
receive inputs from the reviewer that direct the client-side application to generate a multi-media-review-package data structure that describes the composed multi-media review, include the multi-media-review-package data structure in a review-submission message, and transmit the review-submission message to the remote aggregation server.

14. The distributed review-aggregation system of claim 13 wherein the client-side application receives reviewer inputs that direct the client-side application to send a login-request message to the remote aggregation server, in response to which the remote aggregation server returns a session ID for the reviewer.

15. The distributed review-aggregation system of claim 13 wherein the client-side application
receives reviewer inputs that furnish reviewer-profile information to the client-side application, and
receives reviewer inputs that direct the client-side application to send a registration-request message including the reviewer-profile information to the remote aggregation server, in response to which the remote aggregation server stored the profile information, generates a reviewer ID for the reviewer, and returns an acknowledgment.

16. The distributed review-aggregation system of claim 13 wherein the client-side application
receives reviewer inputs that direct the client-side application to send a review-topics-request message to the remote aggregation server, in response to which the remote aggregation server returns a list of topics for which reviews are sought by the distributed review-aggregation system.

17. The distributed review-aggregation system of claim 13 wherein the client-side application displays multiple user-interface pages that together constitute a multi-media-review-composition dialogue, the multiple user-interface pages including:
a page that directs the reviewer to input metadata values that describe the multi-media review;
a page that directs the reviewer to input information using which the client-side application downloads, streams, or inputs one or more media objects;
a page that directs the reviewer to input play intervals for each media object;
a page that displays analysis results produced by the remote aggregation server for the review, and
a page to which the reviewer inputs an acceptance of a displayed agreement for distribution of the review by the distributed review-aggregation system.
